(19) United States
(12) Patent Application Publication
(10) Pub. No.: US 2022/0400235 A1
(43) Pub. Date: Dec. 15, 2022

(54) Dynamic Optical Projection With Wearable Multimedia Devices

(71) Applicant: Humane, Inc., San Francisco, CA (US)

(72) Inventors: Jeffrey Jonathan Spurgat, Phoenix, AZ (US); Imran A. Chaudhri, San Francisco, CA (US)

(21) Appl. No.: 17/838,058

(22) Filed: Jun. 10, 2022

Related U.S. Application Data
(60) Provisional application No. 63/209,943, filed on Jun. 11, 2021.

(51) Int. Cl. H04N 9/31

(52) U.S. Cl. CPC H04N 9/3105; H04N 9/3129; G01S 17/894

(57) ABSTRACT

Systems, methods, devices and non-transitory, computer-readable storage mediums are disclosed for a wearable multimedia device and cloud computing platform with an application ecosystem for processing multimedia data captured by the wearable multimedia device. In an embodiment, a computer-implemented method using the wearable multimedia device includes: determining a three-dimensional (3D) map of a projection surface based on sensor data of at least one sensor of the wearable multimedia device; in response to determining the 3D map of the projection surface, determining a distortion associated with a virtual object to be projected by an optical projection system on the projection surface; adjusting, based on the determined distortion, at least one of (i) one or more characteristics of the virtual object to be projected, or (ii) the optical projection system; and projecting, using the optical projection system and based on a result of the adjusting, the virtual object on the projection surface.

### CROSS-REFERENCE TO RELATED APPLICATION

This application claims priority under 35 USC § 119(e) to U.S. Provisional Patent Application Ser. No. 63/209,943, filed on Jun. 11, 2021, the entire content of which is hereby incorporated by reference.

### TECHNICAL FIELD

This disclosure relates generally to dynamic optical projections with wearable multimedia devices.

### BACKGROUND

High-precision laser scanners have been developed, which can turn any surface into a projection surface. For example, a laser projected image can be projected onto a palm of a user's hand or any other surface. A surface profile of the projection surface may affect an appearance quality of the projected image on the projection surface.

### SUMMARY

Systems, methods, devices and non-transitory, computer-readable storage mediums are disclosed for dynamic optical projections with wearable multimedia devices. A wearable multimedia device can include an optical projection system (e.g., a laser projection system) configured to present information visually to a user using projected light. For example, the optical projection system can project light onto a surface (e.g., a surface of a user's hand, such as on the user's palm, or on a tabletop, among other surfaces) according to a particular spatial and/or temporal pattern, such that the user perceives a virtual object, e.g., representation of an image, video, or text, or a virtual interface (VI) with one or more user interface elements. The user can perform gestures to interact with the virtual object.

In some implementations, the wearable multimedia device detects three-dimensional (3D) variability of a projection surface and then dynamically adjusts optical projection to maintain a consistent and undistorted projection of virtual objects for a user viewing information using the VI. Adjusting the optical projection can include at least one of (i) adjusting one or more characteristics of a to-be-projected virtual object; or (ii) adjusting the optical projection system itself. The wearable multimedia device can detect and map the 3D variability of the projection surface in real time, including a variable depth of the projection surface, a movement of the projection surface, and/or non-perpendicular angles of the projection surface with respect to a direction of optical projection, among others. The dynamic detection can use radar, lidar, and multiple camera sensors, among others, to map the dynamic 3D variability of the projection surface.

In some implementations, the wearable multimedia device uses the 3D map of the projection surface to dynamically adjust a virtual object to be projected to remove any potential distortions caused by the 3D variability of the projection surface, such that the projected virtual object appears to the user on the projection surface without distortions that would otherwise be caused by the 3D variability of the projection surface. For example, the virtual object can be a two-dimensional (2D) image. If the 2D image is directly projected onto the projection surface having the 3D variability, the user may see a distorted 2D image on the projection surface. Instead, using the disclosed implementations, the 2D image can be adjusted or pre-distorted based on the 3D map of the projection surface, e.g., by stretching, shrinking, and/or rotating, among others. The adjusted or pre-distorted 2D image can be translated onto the 3D map of the projection surface, e.g., by texture mapping, which can remove the distortions appearing to the user. Note that the term “pre-distorted” indicates that an original virtual object, e.g., a 2D image, is adjusted before a later distortion caused by a projection surface. The term “undistorted” indicates that the original virtual object is first adjusted or pre-distorted to compensate the later distortion caused by the projection surface such that a final projected virtual object appear undistorted to be like the original virtual object.

The optical projection system itself can be stationary or in motion, e.g., moving when it is used in a wearable multimedia device mounted on the body of the user who is moving. The motion of the optical projection system can be calculated in real time using sensors coupled to the wearable multimedia device, e.g., one of more of accelerometers, gyroscopes, and magnetometers, among others. The motion of the optical projection system itself can also be considered to adjust and maintain a consistent placement of the projected virtual object on the projection surface, in addition to the adjustment of the virtual object due to the 3D variability of the projection surface.

The implementations described herein can provide various technical benefits. For example, the techniques allow a wearable multimedia device to dynamically adjust optical projection to maintain consistent and undistorted surface projection, which can facilitate readability of content on the VI, improving user experience with the wearable multimedia device. The wearable multimedia device can monitor in real time changes to the dimensions or position of the projection surface, and can make a corresponding adjustment for virtual objects that are displayed, or the optical projection system, such that the view of the projected object(s) can be undistorted, seamless, and continuous. The disclosed techniques also enable division of a virtual object to be projected into a plurality of sections according to a plurality of regions of the projection surface with 3D variability, and locally adjust or pre-distort individual sections to avoid or eliminate distortion of the projected virtual object, leading to a more accurate and precise rendition of the virtual object on the projection surface. The techniques also enable use of sensor data from a number of sensors of the wearable multimedia device to dynamically determine a 3D map of the projection surface and/or make corresponding adjustments with programming instructions (or software applications) and/or one or more controllers (or drivers) of the wearable multimedia device, without adding additional customized devices, which can be cost-efficient. Further, the techniques can be applied to project different types of virtual objects on projection surfaces with different surface profiles, such as a user's hand, on another part of the user's body or wearable clothes, or a tabletop, which can improve flexibility and/or applicability of the wearable multimedia device. For example, the techniques can provide a simple and intuitive optically projected (e.g., laser projected) VI that allows a user to access different menus optically projected onto a small surface area by touch or proximity (e.g., hovering) above VI elements projected on the surface, such as on a user's palm. The techniques can make information easier to access on non-traditional projection surfaces, such as a user's palm or another surface area with limited display space and/or uneven surface contours, or that is dynamically changing during the projection. The techniques also make information easier to read or view by a user. The techniques can also outline or highlight a specified content on the project surface itself. The disclosed embodiments summarize and present information on surfaces by, for example, restraining the type of information that is presented using, for example, context sensitive option menus. The disclosed embodiments provide advantages over conventional user interface designs that require scrolling, drilling down, and/or switching views to find information, which are not practical for optically projected virtual interfaces projected onto small surface areas, such as a user's palm.

Implementations of the disclosure provides a computer-implemented method for dynamic optical projection using a wearable multimedia device. The method includes: determining a three-dimensional (3D) map of a projection surface based on sensor data of at least one sensor of the wearable multimedia device; in response to determining the 3D map of the projection surface, determining a distortion associated with a virtual object to be projected by an optical projection system on the projection surface; adjusting, based on the determined distortion, at least one of (i) one or more characteristics of the virtual object to be projected, or (ii) the optical projection system; and projecting, using the optical projection system and based on a result of the adjusting, the virtual object on the projection surface.

In one embodiment, the method further includes: in response to obtaining the virtual object to be projected, presenting the projection surface for the virtual object to be projected.

In one embodiment, presenting the projection surface for the virtual object to be projected includes: determining a field of coverage of the optical projection system; and in response to determining the field of coverage of the optical projection system, adjusting a relative position between the optical projection system and the projection surface to accommodate the projection surface within the field of coverage of the optical projection system.

In one embodiment, determining a three-dimensional (3D) map of a projection surface based on sensor data of at least one sensor of the wearable multimedia device includes: processing, using a 3D mapping algorithm, the sensor data of the at least one sensor of the wearable multimedia device to obtain 3D mapping data for the 3D map of the projection surface.

In one embodiment, adjusting, based on the determined distortion, at least one of (i) one or more characteristics of the virtual object to be projected, or (ii) the optical projection system includes: compensating the distortion to make the virtual object projected on the projection surface appear to be substantially same as the virtual object projected on a flat two-dimensional (2D) surface.

In one embodiment, determining the distortion associated with the virtual object to be projected on the projection surface includes: comparing the 3D map of the projection surface with a flat 2D surface that is orthogonal to an optical projection direction of the optical projection system, the 3D map including one or more uneven regions relative to the flat 2D surface; and determining the distortion associated with the virtual object to be projected on the projection surface based on a result of the comparing.

In one embodiment, determining the distortion associated with the virtual object to be projected on the projection surface comprises: determining one or more sections of the virtual object to be projected on the one or more uneven regions of the projection surface. Adjusting, based on the determined distortion, at least one of (i) one or more characteristics of the virtual object to be projected, or (ii) the optical projection system includes: locally adjusting the one or more characteristics of the one or more sections of the virtual object to be projected based on information about the one or more uneven regions of the projection surface.

In one embodiment, determining the distortion associated with the virtual object to be projected on the projection surface includes: segmenting the projection surface into a plurality of regions based on the 3D map of the projection surface, each of the plurality of regions comprising a corresponding surface that is substantially flat; dividing the virtual object into a plurality of sections according to the plurality of regions of the projection surface, each section of the plurality of sections of the virtual object corresponding to a respective region on which the section of the virtual object is to be projected by the optical projection system; and determining the distortion associated with the virtual object based on information of the plurality of regions of the projection surface and information of the plurality of sections of the virtual object.

In one embodiment, adjusting, based on the determined distortion, at least one of (i) one or more characteristics of the virtual object to be projected, or (ii) the optical projection system includes: locally adjusting one or more characteristics of each of the plurality of sections of the virtual object to be projected based on the information about the plurality of regions of the projection surface and the information about the plurality of sections of the virtual object.

In one embodiment, locally adjusting one or more characteristics of each of the plurality of sections of the virtual object to be projected includes: for each section of the plurality of sections of the virtual object to be projected, mapping the section to the respective region of the plurality of regions of the projection surface using a content mapping algorithm, and adjusting the one or more characteristics of the section based on the mapped section on the respective region.

In one embodiment, determining the distortion associated with the virtual object to be projected on the projection surface includes: estimating a projection of the virtual object on the projection surface prior to projecting the virtual object on the projection surface; and determining the distortion based on a comparison between the virtual object to be projected and the estimated projection of the virtual object.

In one embodiment, the one or more characteristics of the virtual object include at least one of: a magnification ratio, a resolution, a stretching ratio, a shrinking ratio, or a rotation angle.

In one embodiment, adjusting, based on the determined distortion, at least one of (i) one or more characteristics of the virtual object to be projected, or (ii) the optical projection system includes at least one of: adjusting a distance between the optical projection system and the projection surface, or tilting or rotating an optical projection from the optical projection system with respect to the projection surface.

In one embodiment, adjusting, based on the determined distortion, at least one of (i) one or more characteristics of the virtual object to be projected, or (ii) the optical projection system includes: adjusting content of the virtual object to be projected on the projection surface.

In one embodiment, adjusting content of the virtual object to be projected on the projection surface includes one of: in response to determining that the projection surface has a larger surface area, increasing an amount of content of the virtual object to the be projected on the projection surface, or in response to determining that the projection surface has a smaller surface area, decreasing the amount of the content of the virtual object to the be projected on the projection surface.

In one embodiment, the method includes: capturing, by a camera sensor of the wearable multimedia device, an image of the projected virtual object on the projection surface; and determining the distortion associated with the virtual object at least partially based on the captured image of the projected virtual object on the projection surface.

In one embodiment, the sensor data includes at least one of: variable depths of the projection surface, a movement of the projection surface, a motion of the optical projection system, or a non-perpendicular angle of the projection surface with respect to a direction of an optical projection of the optical projection system.

In one embodiment, the at least one sensor of the wearable multimedia device includes: at least one of an accelerometer, a gyroscope, a magnetometer, a depth sensor, a motion sensor, a radar, a lidar, a time of flight (TOF) sensor, or one or more camera sensors.

In one embodiment, the method includes: dynamically updating the 3D map of the projection surface based on updated sensor data of the at least one sensor.

In one embodiment, the virtual object comprises at least one of: one or more images, videos, or texts, or a virtual interface including at least one of one or more user interface elements or content information.

In one embodiment, the virtual object includes one or more concentric rings with a plurality of nodes embedded in each ring, each node representing an application.

In one embodiment, the method further includes: detecting, based on second sensor data from the at least one sensor, a user input selecting a particular node of the plurality of nodes of at least one of the one or more concentric rings through touch or proximity, and responsive to the user input, causing invocation of an application corresponding to the selected particular node.

In one embodiment, the method further includes: inferring context based on second sensor data from the at least one sensor of the wearable multimedia device, and generating, based on the inferred context, a first virtual interface (VI) with one or more first VI elements to be projected on the projection surface. The virtual object comprises the first VI with the one or more first VI elements.

In one embodiment, the method further includes: projecting, using the optical projection system, the first VI with the one or more first VI elements on the projection surface, receiving a user input directed to a first VI element of the one or more first VI elements, and responsive to the user input, generating a second VI that includes one or more concentric rings with icons for invoking corresponding applications, one or more icons more relevant to the inferred context being presented differently than one or more other icons. The virtual object includes the second VI with the one or more concentric rings with the icons.

In one embodiment, a method includes: projecting, using an optical projector of a wearable multimedia device, a virtual interface (VI) on a surface, the VI including concentric rings with a plurality of nodes embedded in each ring, each node representing an application; detecting, based on sensor data from at least one sensor of the wearable multimedia device, user input selecting a particular node of the plurality of nodes of at least one of the plurality of rings through touch or proximity; and responsive to the input, causing, with at least one processor, invocation of an application corresponding to the selected node.

In one embodiment, a wearable multimedia device includes: an optical projector, a camera, a depth sensor, at least one processor, and at least one memory storing instructions that when executed by the at least one processor, cause the at least one processor to perform operations including: projecting, using the optical projector, a virtual interface (VI) on a surface, the VI comprising concentric rings with a plurality of nodes embedded in each ring, each node representing an application; detecting, based on sensor data from at least one of the camera or the depth sensor, user input selecting a particular node of the plurality of nodes of at least one of the plurality of rings through touch or proximity; and responsive to the input, causing invocation of an application corresponding to the selected node.

It is appreciated that methods in accordance with this disclosure may include any combination of the aspects and features described herein. That is, methods in accordance with this disclosure are not limited to the combinations of aspects and features specifically described herein, but also include any combination of the aspects and features provided.

This disclosure also provides one or more non-transitory computer-readable storage media coupled to one or more processors and having instructions stored thereon which, when executed by the one or more processors, cause the one or more processors to perform operations in accordance with embodiments of the methods provided herein.

This disclosure further provides a system for implementing the methods provided herein. The system includes an optical projection system, at least one sensor, one or more processors and one or more memories coupled to the one or more processors having instructions stored thereon which, when executed by the one or more processors, cause the one or more processors to perform operations in accordance with embodiments of the methods provided herein.

The details of the disclosed embodiments are set forth in the accompanying drawings and the description below. Other features, objects and advantages are apparent from the description, drawings and claims.

### DESCRIPTION OF DRAWINGS

FIG. 1 is a block diagram of an operating environment for a wearable multimedia device and cloud computing platform with an application ecosystem for processing multimedia data captured by the wearable multimedia device, according to an embodiment.

FIG. 2A is a block diagram of a data processing system implemented by the cloud computing platform of FIG. 1, according to an embodiment.

FIG. 2B illustrates a messaging system for a wearable multimedia device, according to an embodiment.

FIG. 3 is a block diagram of a data processing pipeline for processing a context data stream, according to an embodiment.

FIG. 4 is a block diagram of another data processing for processing a context data stream for a transportation application, according to an embodiment.

FIG. 5 illustrates data objects used by the data processing system of FIG. 2A, according to an embodiment.

FIG. 6 is flow diagram of a data pipeline process, according to an embodiment.

FIG. 7 is an architecture for the cloud computing platform, according to an embodiment.

FIG. 8 is an architecture for the wearable multimedia device, according to an embodiment.

FIG. 9 is a system block diagram of a projector architecture, according to an embodiment.

FIG. 10 is a diagram of an example virtual interface projected on a user's palm as a projection surface, according to an embodiment.

FIGS. 11A-11J are diagrams of example optical projections of virtual VI elements, according to an embodiment.

FIGS. 12A-12C are diagrams of example optical projections of virtual objects on a projection surface, according to an embodiment.

FIG. 12D is a diagram of an example optical projection of a virtual object on an uneven projection surface, according to an embodiment.

FIGS. 13A-13E are diagrams of example operations relating to managing optical projection with a wearable multimedia device, according to an embodiment.

FIG. 14 is flow diagram of a process for managing optical projection with a wearable multimedia device, according to an embodiment.

FIG. 15 is a flow diagram of process of generating VI projections, according to an embodiment.

The same reference symbol used in various drawings indicates like elements.

### DETAILED DESCRIPTION

### Example Wearable Multimedia Device

The features and processes described herein can be implemented on a wearable multimedia device. In an embodiment, the wearable multimedia device is a lightweight, small form factor, battery-powered device that can be attached to a user's clothing or an object using a tension clasp, interlocking pin back, magnet, or any other attachment mechanism. The wearable multimedia device includes a digital image capture device (e.g., a camera with a 180° FOV with optical image stabilizer (OIS)) that allows a user to spontaneously and/or continuously capture multimedia data (e.g., video, audio, depth data, biometric data) of life events (“moments”) and document transactions (e.g., financial transactions) with minimal user interaction or device set-up. The multimedia data (“context data”) captured by the wireless multimedia device is uploaded to a cloud computing platform with an application ecosystem that allows the context data to be processed, edited and formatted by one or more applications (e.g., Artificial Intelligence (AI) applications) into any desired presentation format (e.g., single image, image stream, video clip, audio clip, multimedia presentation, or image gallery) that can be downloaded and replayed on the wearable multimedia device and/or any other playback device. For example, the cloud computing platform can transform video data and audio data into any desired filmmaking style (e.g., documentary, lifestyle, candid, photojournalism, sport, street) specified by the user.

In an embodiment, the context data is processed by server computer(s) of the cloud computing platform based on user preferences. For example, images can be color graded, stabilized and cropped perfectly to the moment the user wants to relive based on the user preferences. The user preferences can be stored in a user profile created by the user through an online account accessible through a website or portal, or the user preferences can be learned by the platform over time (e.g., using machine learning). In an embodiment, the cloud computing platform is a scalable distributed computing environment. For example, the cloud computing platform can be a distributed streaming platform (e.g., Apache Kafka™) with real-time streaming data pipelines and streaming applications that transform or react to streams of data.

In an embodiment, the user can start and stop a context data capture session on the wearable multimedia device with a simple touch gesture (e.g., a tap or swipe), by speaking a command or any other input mechanism. All or portions of the wearable multimedia device can automatically power down when it detects that it is not being worn by the user using one or more sensors (e.g., proximity sensor, optical sensor, accelerometers, gyroscopes).

The context data can be encrypted and compressed and stored in an online database associated with a user account using any desired encryption or compression technology. The context data can be stored for a specified period of time that can be set by the user. The user can be provided through a website, portal or mobile application with opt-in mechanisms and other tools for managing their data and data privacy.

In an embodiment, the context data includes point cloud data to provide three-dimensional (3D) surface mapped objects that can be processed using, for example, augmented reality (AR) and virtual reality (VR) applications in the application ecosystem. The point cloud data can be generated by a depth sensor (e.g., LiDAR or Time of Flight (TOF)) embedded on the wearable multimedia device.

In an embodiment, the wearable multimedia device includes a Global Navigation Satellite System (GNSS) receiver (e.g., Global Positioning System (GPS)) and one or more inertial sensors (e.g., accelerometers, gyroscopes) for determining the location and orientation of the user wearing the device when the context data was captured. In an embodiment, one or more images in the context data can be used by a localization application, such as a visual odometry application, in the application ecosystem to determine the position and orientation of the user.

In an embodiment, the wearable multimedia device can also include one or more environmental sensors, including but not limited to: an ambient light sensor, magnetometer, pressure sensor, voice activity detector, etc. This sensor data can be included in the context data to enrich a content presentation with additional information that can be used to capture the moment.

In an embodiment, the wearable multimedia device can include one or more biometric sensors, such as a heart rate sensor, fingerprint scanner, etc. This sensor data can be included in the context data to document a transaction or to indicate the emotional state of the user during the moment (e.g., elevated heart rate could indicate excitement or fear).

In an embodiment, the wearable multimedia device includes a headphone jack connecting a headset or earbuds, and one or more microphones for receiving voice command and capturing ambient audio. In an alternative embodiment, the wearable multimedia device includes short range communication technology, including but not limited to Bluetooth, IEEE 802.15.4 (ZigBee™) and near field communications (NFC). The short range communication technology can be used to wirelessly connect to a wireless headset or earbuds in addition to, or in place of the headphone jack, and/or can wirelessly connect to any other external device (e.g., a computer, printer, projector, television and other wearable devices).

In an embodiment, the wearable multimedia device includes a wireless transceiver and communication protocol stacks for a variety of communication technologies, including Wi-Fi, 3G, 4G and 5G communication technologies. In an embodiment, the headset or earbuds also include sensors (e.g., biometric sensors, inertial sensors) that provide information about the direction the user is facing, to provide commands with head gestures or playback of spatial audio, etc. In an embodiment, the camera direction can be controlled by the head gestures, such that the camera view follows the user's view direction. In an embodiment, the wearable multimedia device can be embedded in or attached to the user's glasses.

In an embodiment, the wearable multimedia device includes a projector (e.g., a laser projector) or other digital projection technology (e.g., Liquid Crystal on Silicon (LCoS or LCOS), Digital Light Processing (DLP) or Liquid Chrystal Display (LCD) technology), or can be wired or wirelessly coupled to an external projector, that allows the user to replay a moment on a surface such as a wall or table top or on a surface of the user's hand (e.g., the user's palm). In another embodiment, the wearable multimedia device includes an output port that can connect to a projector or other output device.

In an embodiment, the wearable multimedia capture device includes a touch surface responsive to touch gestures (e.g., a tap, multi-tap or swipe gesture). The wearable multimedia device may include a small display for presenting information and one or more light indicators to indicate on/off status, power conditions or any other desired status.

In an embodiment, the cloud computing platform can be driven by context-based gestures (e.g., air gesture) in combination with speech queries, such as the user pointing to an object in their environment and saying: “What is that building?” The cloud computing platform uses the air gesture to narrow the scope of the viewport of the camera and isolate the building. One or more images of the building are captured and optionally cropped (e.g., to protect privacy) and sent to the cloud computing platform where an image recognition application can run an image query and store or return the results to the user. Air and touch gestures can also be performed on a projected ephemeral display, for example, responding to user interface elements projected on a surface.

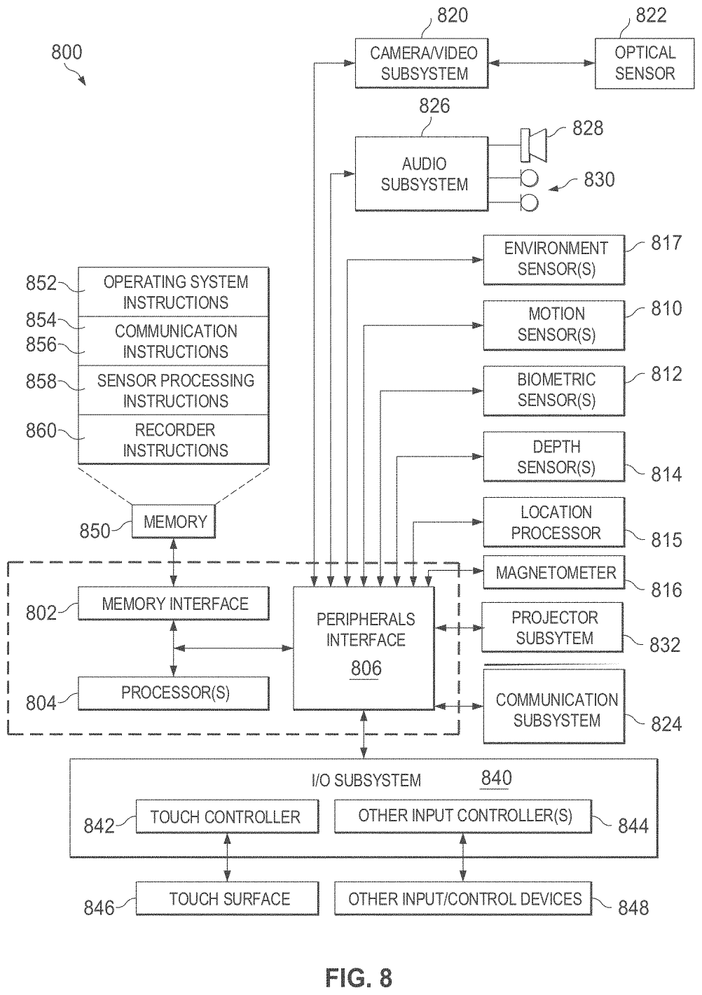

In an embodiment, the context data can be encrypted on the device and on the cloud computing platform so that only the user or any authorized viewer can relive the moment on a connected screen (e.g., smartphone, computer, television, etc.) or as a projection on a surface. An example architecture for the wearable multimedia device is described in reference to FIG. 8.

In addition to personal life events, the wearable multimedia device simplifies the capture of financial transactions that are currently handled by smartphones. The capture of every day transactions (e.g., business transactions, micro transactions) is made simpler, faster and more fluid by using sight assisted contextual awareness provided by the wearable multimedia device. For example, when the user engages in a financial transaction (e.g., making a purchase), the wearable multimedia device will generate data memorializing the financial transaction, including a date, time, amount, digital images or video of the parties, audio (e.g., user commentary describing the transaction) and environment data (e.g., location data). The data can be included in a multimedia data stream sent to the cloud computing platform, where it can be stored online and/or processed by one or more financial applications (e.g., financial management, accounting, budget, tax preparation, inventory, etc.).

In an embodiment, the cloud computing platform provides graphical user interfaces on a web site or portal that allow various third party application developers to upload, update and manage their applications in an application ecosystem. Some example applications can include but are not limited to: personal live broadcasting (e.g., Instagram™ Life, Snapchat™), senior monitoring (e.g., to ensure that a loved one has taken their medicine), memory recall (e.g., showing a child's soccer game from last week) and personal guide (e.g., AI enabled personal guide that knows the location of the user and guides the user to perform an action).

In an embodiment, the wearable multimedia device includes one or more microphones and a headset. In one embodiment, the headset wire includes the microphone. In an embodiment, a digital assistant is implemented on the wearable multimedia device that responds to user queries, requests and commands. For example, the wearable multimedia device worn by a parent captures moment context data for a child's soccer game, and in particular a “moment” where the child scores a goal. The user can request (e.g., using a speech command) that the platform create a video clip of the goal and store it in their user account. Without any further actions by the user, the cloud computing platform identifies the correct portion of the moment context data (e.g., using face recognition, visual or audio cues) when the goal is scored, edits the moment context data into a video clip, and stores the video clip in a database associated with the user account.

In an embodiment, the wearable multimedia device can include photovoltaic surface technology to sustain battery life and inductive charging circuitry (e.g., Qi) to allow for inductive charging on charge mats and wireless over-the-air (OTA) charging.

In an embodiment, the wearable multimedia device is configured to magnetically couple or mate with a rechargeable portable battery pack. The portable battery pack includes a mating surface that has permanent magnet (e.g., N pole) disposed thereon, and the wearable multimedia device has a corresponding mating surface that has permanent magnet (e.g., S pole) disposed thereon. Any number of permanent magnets having any desired shape or size can be arranged in any desired pattern on the mating surfaces.

The permanent magnets hold portable battery pack and wearable multimedia device together in a mated configuration with clothing (e.g., a user's shirt) in between. In an embodiment, the portable battery pack and wearable multimedia device have the same mating surface dimensions, such that there is no overhanging portions when in a mated configuration. A user magnetically fastens the wearable multimedia device to their clothing by placing the portable battery pack underneath their clothing and placing the wearable multimedia device on top of portable battery pack outside their clothing, such that permanent magnets attract each other through the clothing.

In an embodiment, the portable battery pack has a built-in wireless power transmitter which is used to wirelessly power the wearable multimedia device while in the mated configuration using the principle of resonant inductive coupling. In an embodiment, the wearable multimedia device includes a built-in wireless power receiver which is used to receive power from the portable battery pack while in the mated configuration.

### System Overview

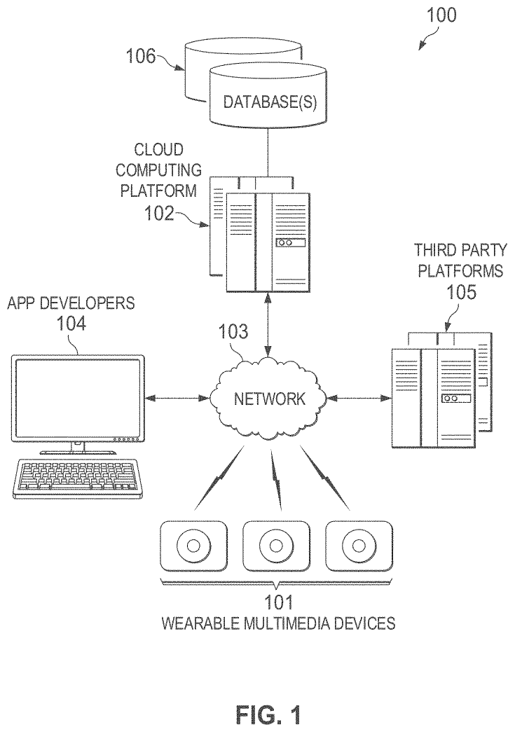

FIG. 1 is a block diagram of an operating environment for a wearable multimedia device and cloud computing platform with an application ecosystem for processing multimedia data captured by the wearable multimedia device, according to an embodiment. Operating environment 100 includes wearable multimedia devices 101, cloud computing platform 102, network 103, application (“app”) developers 104 and third party platforms 105. Cloud computing platform 102 is coupled to one or more databases 106 for storing context data uploaded by wearable multimedia devices 101.

As previously described, wearable multimedia devices 101 are lightweight, small form factor, battery-powered devices that can be attached to a user's clothing or an object using a tension clasp, interlocking pin back, magnet or any other attachment mechanism. Wearable multimedia devices 101 include a digital image capture device (e.g., a camera with a 180° FOV and OIS) that allows a user to spontaneously capture multimedia data (e.g., video, audio, depth data) of “moments” and document every day transactions (e.g., financial transactions) with minimal user interaction or device set-up. The context data captured by wearable multimedia devices 101 are uploaded to cloud computing platform 102. Cloud computing platform 102 includes an application ecosystem that allows the context data to be processed, edited and formatted by one or more server side applications into any desired presentation format (e.g., single image, image stream, video clip, audio clip, multimedia presentation, images gallery) that can be downloaded and replayed on the wearable multimedia device and/or other playback device.

By way of example, at a child's birthday party a parent can clip the wearable multimedia device on their clothing (or attached the device to a necklace or chain and wear around their neck) so that the camera lens is facing in their view direction. The camera includes a 180° FOV that allows the camera to capture almost everything that the user is currently seeing. The user can start recording by simply tapping the surface of the device or pressing a button or speaking a command. No additional set-up is required. A multimedia data stream (e.g., video with audio) is recorded that captures the special moments of the birthday (e.g., blowing out the candles). This “context data” is sent to cloud computing platform 102 in real-time through a wireless network (e.g., Wi-Fi, cellular). In an embodiment, the context data is stored on the wearable multimedia device so that it can be uploaded at a later time. In another embodiment, the user can transfer the context data to another device (e.g., personal computer hard drive, smartphone, tablet computer, thumb drive) and upload the context data to cloud computing platform 102 at a later time using an application.

In an embodiment, the context data is processed by one or more applications of an application ecosystem hosted and managed by cloud computing platform 102. Applications can be accessed through their individual application programming interfaces (APIs). A custom distributed streaming pipeline is created by cloud computing platform 102 to process the context data based on one or more of the data type, data quantity, data quality, user preferences, templates and/or any other information to generate a desired presentation based on user preferences. In an embodiment, machine learning technology can be used to automatically select suitable applications to include in the data processing pipeline with or without user preferences. For example, historical user context data stored in a database (e.g., NoSQL database) can be used to determine user preferences for data processing using any suitable machine learning technology (e.g., deep learning or convolutional neural networks).

In an embodiment, the application ecosystem can include third party platforms 105 that process context data. Secure sessions are set-up between cloud computing platform 102 and third party platforms 105 to send/receive context data. This design allows third party app providers to control access to their application and to provide updates. In other embodiments, the applications are run on servers of cloud computing platform 102 and updates are sent to cloud computing platform 102. In the latter embodiment, app developers 104 can use an API provided by cloud computing platform 102 to upload and update applications to be included in the application ecosystem.

### Example Data Processing System

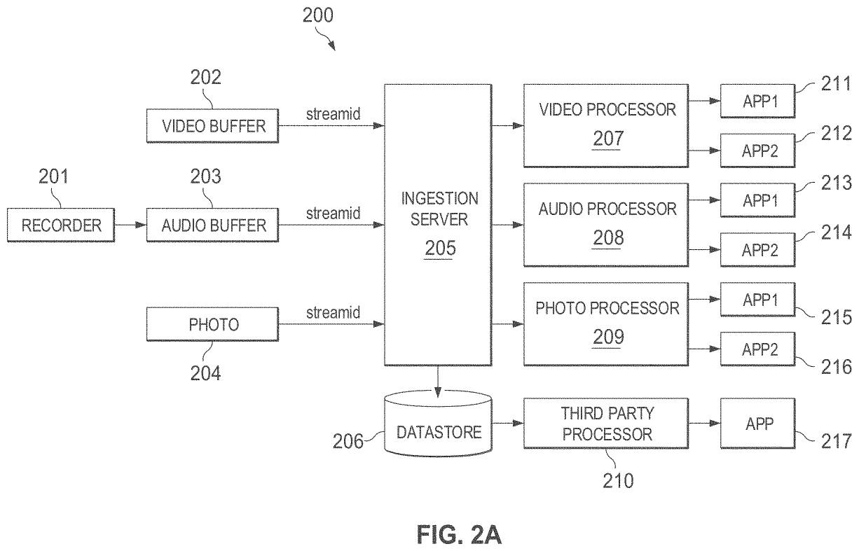

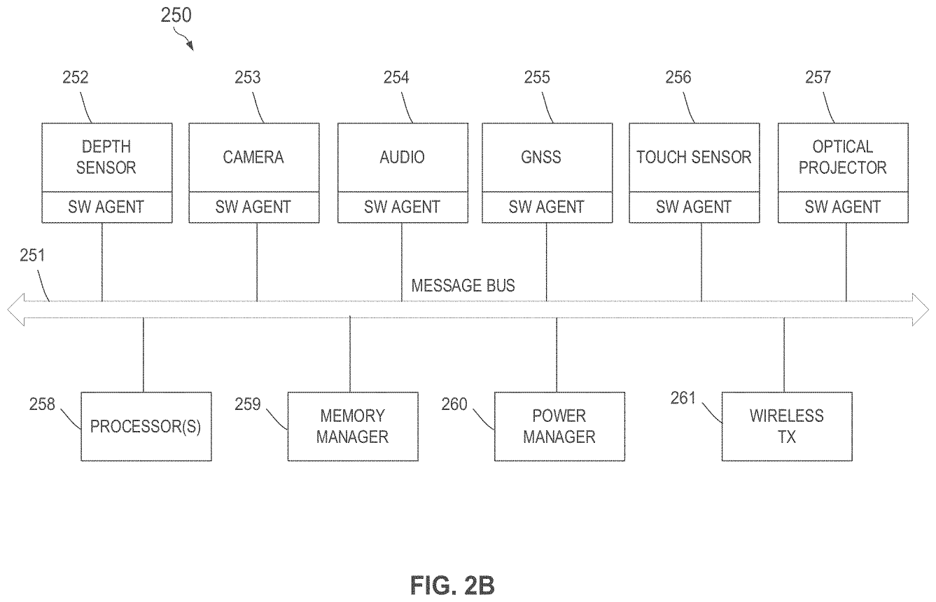

FIG. 2A is a block diagram of a data processing system implemented by the wearable multimedia device and the cloud computing platform of FIG. 1, according to an embodiment. Data processing system 200 includes recorder 201, video buffer 202, audio buffer 203, photo buffer 204, ingestion server 205, data store 206, video processor 207, audio processor 208, photo processor 209 and third party processor 210.

A recorder 201 (e.g., a software application) running on a wearable multimedia device records video, audio and photo data (“context data”) captured by a camera and audio subsystem, and stores the data in buffers 202, 203, 204, respectively. This context data is then sent (e.g., using wireless OTA technology) to ingestion server 205 of cloud computing platform 102. In an embodiment, the data can be sent in separate data streams each with a unique stream identifier (streamid). The streams are discrete pieces of data that may contain the following example attributes: location (e.g., latitude, longitude), user, audio data, video stream of varying duration and N number of photos. A stream can have a duration of 1 to MAXSTREAM_LEN seconds, where in this example MAXSTREAM_LEN=20 seconds.

Ingestion server 205 ingests the streams and creates a stream record in data store 206 to store the results of processors 207-209. In an embodiment, the audio stream is processed first and is used to determine the other streams that are needed. Ingestion server 205 sends the streams to the appropriate processor 207-209 based on streamid. For example, the video stream is sent to video processor 207, the audio stream is sent to audio processor 208 and the photo stream is sent to photo processor 209. In an embodiment, at least a portion of data collected from the wearable multimedia device (e.g., image data) is processed into metadata and encrypted so that it can be further processed by a given application and sent back to the wearable multimedia device or other device.

Processors 207-209 can run proprietary or third party applications as previously described. For example, video processor 207 can be a video processing server that sends raw video data stored in video buffer 202 to a set of one or more image processing/editing applications 211, 212 based on user preferences or other information. Processor 207 sends requests to applications 211, 212, and returns the results to ingestion server 205. In an embodiment, third party processor 210 can process one or more of the streams using its own processor and application 217. In another example, audio processor 208 can be an audio processing server that sends speech data stored in audio buffer 203 to speech-to-text converter applications 213, 214. In another example, photo processor 209 can be an image processing server that sends image data stored in photo buffer 204 to image processing applications 215, 216.

### Example Messaging System

FIG. 2B illustrates a messaging system 250 for a small form factor, wearable multimedia device, according to an embodiment. System 250 includes multiple independent components/blocks/peripherals, including depth sensor 252, camera 253 (e.g., a wide FOV camera), audio subsystem 254 (e.g., including microphone(s), audio amplifier, loudspeaker, codec, etc.), global navigation satellite system (GNSS) receiver 255 (e.g., a GPS receiver chip), touch sensor 256 (e.g., a capacitive touch surface), optical projector 257, processors 258, memory manager 259, power manager 260 and wireless transceiver (TX) 261 (e.g., WIFI, Bluetooth, Near Field (NF) hardware and software stacks). Each hardware component 252-261 communicates with other hardware components 252-261 over message bus 252 through its own dedicated software agent or driver. In an embodiment, each component operates independent of other components and can generate data at different rates. Each component 252-257 is a subscriber (data consumer), data source or both subscriber and data source on bus 251.

For example, depth sensor 252 generates a stream of raw point cloud data and uses its software agent/driver to place the data stream on message bus 251 for subscribing components to retrieve and use. Camera 253 generates a data stream of image data (e.g., Red, Green Blue (RGB) frames) and uses its software agent/driver to place the raw image data stream on message bus 251. Audio subsystem 254 generates a stream of audio data, such as user speech input from a microphone, and uses its software agent/driver to place the audio data stream on message bus 251. GNSS 255 generates a stream of location data for the device (e.g., latitude, longitude, altitude) and uses its software agent/driver to place the location data stream on message bus 251. Touch sensor 256 generates a stream of touch data (e.g., taps, gestures), and uses its software agent/driver to place the touch data stream on message bus 251.

In an embodiment, an inertial measurement unit (IMU) which includes one or more of accelerometers, angular rate sensors, magnetometers or altitude sensors are coupled to message bus 251, and provide raw sensor data or processed sensor data (e.g., filtered data, transformed data) to other components coupled to message bus 251.

Optical projector 257, processors 258, memory manager 259, power manager 260 and wireless TX 261 are core system resources of the device and are coupled together through one or more buses not shown (e.g., system bus, power bus). In an embodiment, the core system resources also have dedicated software agents or drivers to provide system information to the other components, such as battery state of charge (SOC), memory available, processor bandwidth, data buffering for remote sources (e.g., WIFI, Bluetooth data), etc. Each of the components can use the system information to, for example, adjust to changes in the core system resources (e.g., adjust data capture rate, duty cycle).

As defined herein, a “software agent” is code that operates autonomously to source and/or acquire data from a message bus or other data pipeline on behalf of a hardware component or software application. In an embodiment, software agents run on the operating system of the device and use Application Programming Interface (API) calls for low-level memory access through memory manager 259. In an embodiment, a software agent can acquire data from a shared system memory location and/or secured memory location (e.g., to acquire encryption keys or other secret data). In an embodiment, a software agent is daemon process that runs in the background.

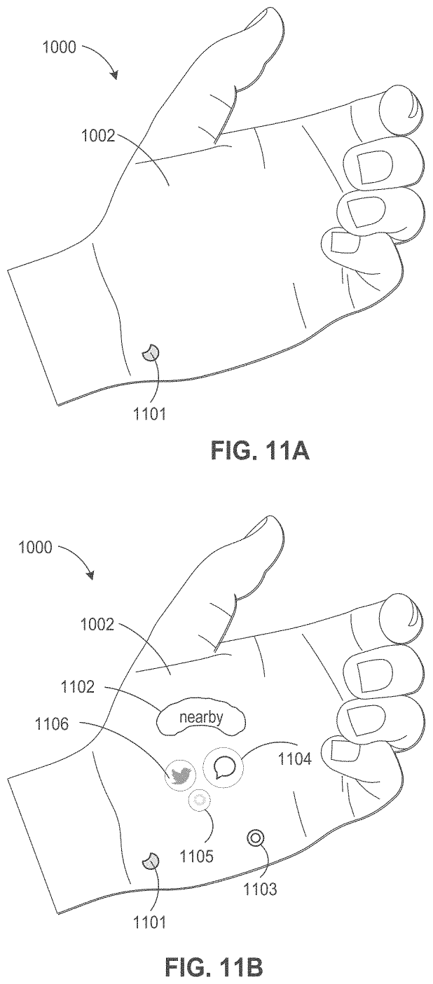

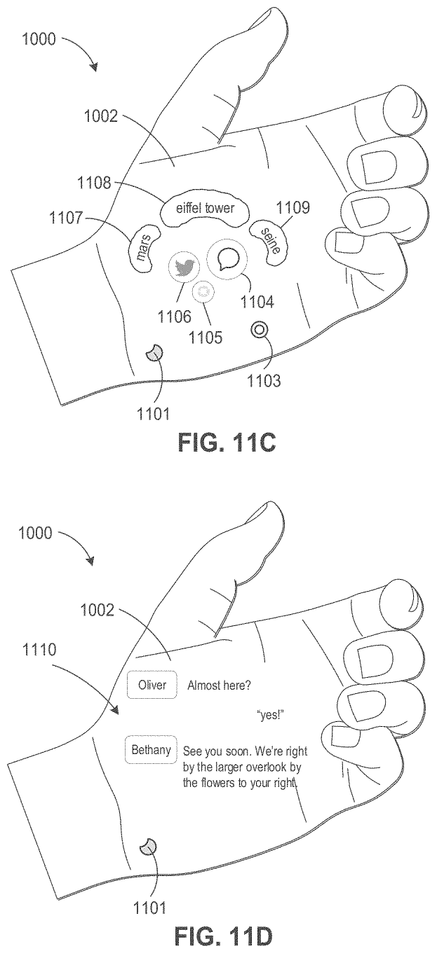

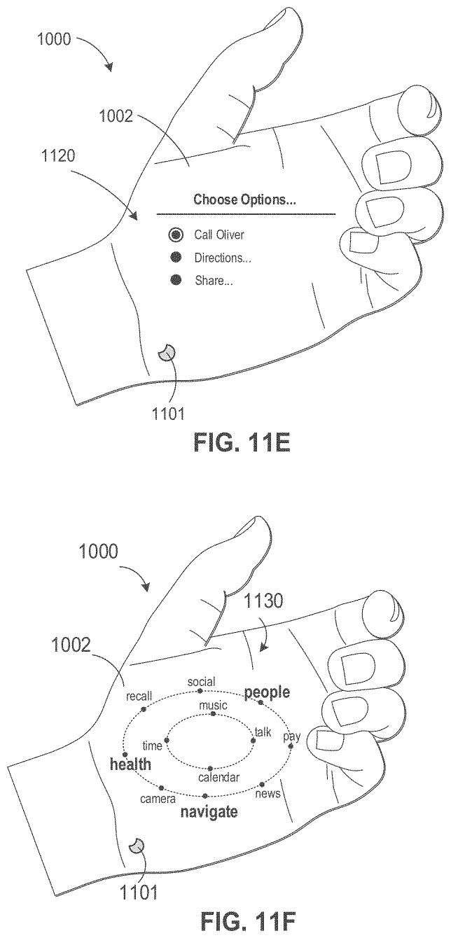

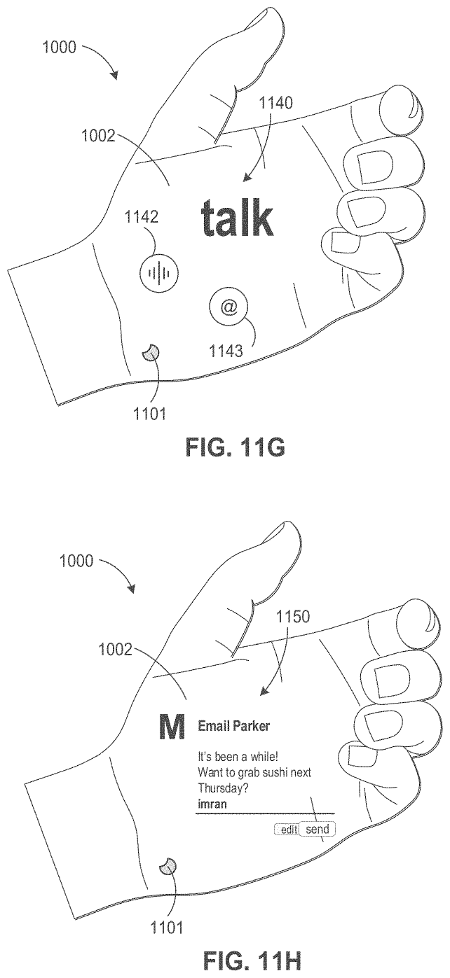

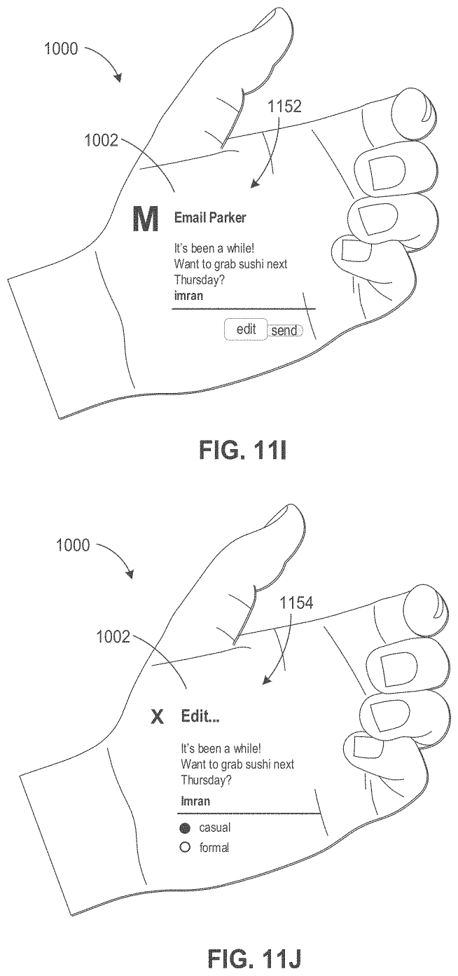

In an embodiment, the camera and/or depth sensor 252, 253 can be used to determine user input using an optical projection (e.g., a laser projection) of a keyboard, button, slider, rotary dial, or any other graphical user interface affordance. For example, the optical projector 257 can be a laser projector or any other projector that can emit light for projection. The optical projector 257 can be used to project one or more VI elements (e.g., virtual buttons, virtual keyboard, virtual slider, virtual dial, etc.) on any desired surface, such as the palm of a user's hand, as described in reference to FIGS. 11A-11J. The camera sensor 252 can register the location of the VI elements in the image frame, and the depth sensor 253 can be used with the camera image to register the location of the user's finger(s) to determine which VI(s) the user is touching.

### Example Scene Identification Application

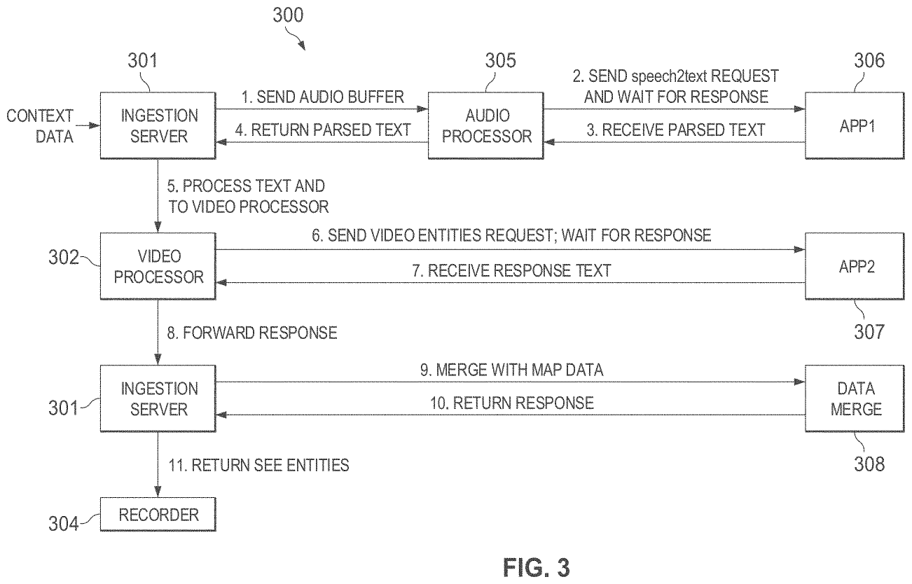

FIG. 3 is a block diagram of a data processing pipeline for processing a context data stream, according to an embodiment. In this embodiment, data processing pipeline 300 is created and configured to determine what the user is seeing based on the context data captured by a wearable multimedia device worn by the user. Ingestion server 301 receives an audio stream (e.g., including user commentary) from audio buffer 203 of wearable multimedia device and sends the audio stream to audio processor 305. Audio processor 305 sends the audio stream to app 306 which performs speech-to-text conversion and returns parsed text to audio processor 305. Audio processor 305 returns the parsed text to ingestion server 301.

Video processor 302 receives the parsed text from ingestion server 301 and sends a requests to video processing app 307. Video processing app 307 identifies objects in the video scene and uses the parsed text to label the objects. Video processing app 307 sends a response describing the scene (e.g., labeled objects) to video processor 302. Video processor then forwards the response to ingestion server 301. Ingestion server 301 sends the response to data merge process 308, which merges the response with the user's location, orientation and map data. Data merge process 308 returns a response with a scene description to recorder 304 on the wearable multimedia device. For example, the response can include text describing the scene as the child's birthday party, including a map location and a description of objects in the scene (e.g., identify people in the scene). Recorder 304 associates the scene description with the multimedia data (e.g., using a streamid) stored on the wearable multimedia device. When the user recalls the data, the data is enriched with the scene description.

In an embodiment, data merge process 308 may use more than just location and map data. There can also be a notion of ontology. For example, the facial features of the user's Dad captured in an image can be recognized by the cloud computing platform, and be returned as “Dad” rather than the user's name, and an address such as “555 Main Street, San Francisco, Calif.” can be returned as “Home.” The ontology can be specific to the user and can grow and learn from the user's input.

### Example Transportation Application

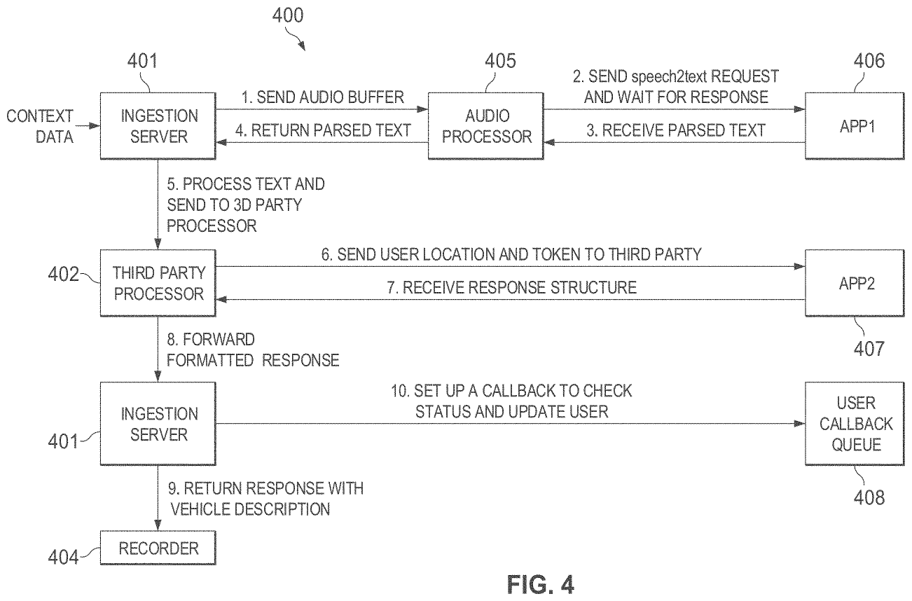

FIG. 4 is a block diagram of another data processing for processing a context data stream for a transportation application, according to an embodiment. In this embodiment, data processing pipeline 400 is created to call a transportation company (e.g., Uber®, Lyft®) to get a ride home. Context data from a wearable multimedia device is received by ingestion server 401 and an audio stream from an audio buffer 203 is sent to audio processor 405. Audio processor 405 sends the audio stream to app 406, which converts the speech to text. The parsed text is returned to audio processor 405, which returns the parsed text to ingestion server 401 (e.g., a user speech request for transportation). The processed text is sent to third party processor 402. Third party processor 402 sends the user location and a token to a third party application 407 (e.g., Uber® or Lyft™® application). In an embodiment, the token is an API and authorization token used to broker a request on behalf of the user. Application 407 returns a response data structure to third party processor 402, which is forwarded to ingestion server 401. Ingestion server 401 checks the ride arrival status (e.g., ETA) in the response data structure and sets up a callback to the user in user callback queue 408. Ingestion server 401 returns a response with a vehicle description to recorder 404, which can be spoken to the user by a digital assistant through a loudspeaker on the wearable multimedia device, or through the user's headphones or earbuds via a wired or wireless connection.

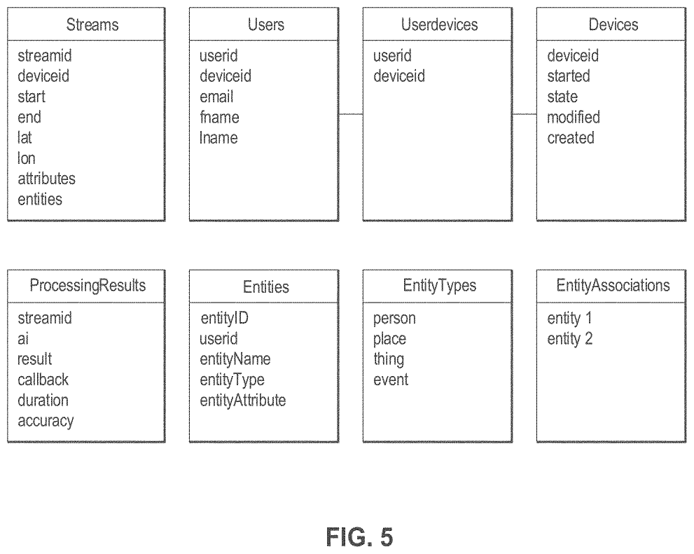

FIG. 5 illustrates data objects used by the data processing system of FIG. 2A, according to an embodiment. The data objects are part of software component infrastructure instantiated on the cloud computing platform. A “streams” object includes the data streamid, deviceid, start, end, lat, lon, attributes and entities. “Streamid” identifies the stream (e.g., video, audio, photo), “deviceid” identifies the wearable multimedia device (e.g., a mobile device ID), “start” is the start time of the context data stream, “end” is the end time of the context data stream, “lat” is the latitude of the wearable multimedia device, “lon” is the longitude of the wearable multimedia device, “attributes” include, for example, birthday, facial points, skin tone, audio characteristics, address, phone number, etc., and “entities” make up an ontology. For example, the name “John Do” would be mapped to “Dad” or “Brother” depending on the user.

A “Users” object includes the data userid, deviceid, email, fname and lname. Userid identifies the user with a unique identifier, deviceid identifies the wearable device with a unique identifier, email is the user's registered email address, fname is the user's first name and lname is the user's last name. A “Userdevices” object includes the data userid and deviceid. A “devices” object includes the data deviceid, started, state, modified and created. In an embodiment, deviceid is a unique identifier for the device (e.g., distinct from a MAC address). Started is when the device was first started. State is on/off/sleep. Modified is the last modified date, which reflects the last state change or operating system (OS) change. Created is the first time the device was turned on.

A “ProcessingResults” object includes the data streamid, ai, result, callback, duration and accuracy. In an embodiment, streamid is each user stream as a Universally Unique Identifier (UUID). For example, a stream that was started from 8:00 AM to 10:00 AM will have id:15h158dhb4 and a stream that starts from 10:15 AM to 10:18 AM will have a UUID that was contacted for this stream. AI is the identifier for the platform application that was contacted for this stream. Result is the data sent from the platform application. Callback is the callback that was used (versions can change hence the callback is tracked in case the platform needs to replay the request). Accuracy is the score for how accurate the result set is. In an embodiment, processing results can be used for multiple tasks, such as 1) to inform the merge server of the full set of results, 2) determine the fastest AI so that user experience can be enhanced, and 3) determine the most accurate ai. Depending on the use case, one may favor speed over accuracy or vice versa.

An “Entities” object includes the data entityID, userID, entityName, entityType and entityAttribute. EntityID is a UUID for the entity and an entity having multiple entries where the entityID references the one entity. For example, “Barack Obama” would have an entityID of 144, which could be linked in an associations table to POTUS44 or “Barack Hussein Obama” or “President Obama.” UserID identifies the user that the entity record was made for. EntityName is the name that the userID would call the entity. For example, Malia Obama's entityName for entityID 144 could be “Dad” or “Daddy.” EntityType is a person, place or thing. EntityAttribute is an array of attributes about the entity that are specific to the userID's understanding of that entity. This maps entities together so that when, for example, Malia makes the speech query: “Can you see Dad?”, the cloud computing platform can translate the query to Barack Hussein Obama and use that in brokering requests to third parties or looking up information in the system.

### Example Process

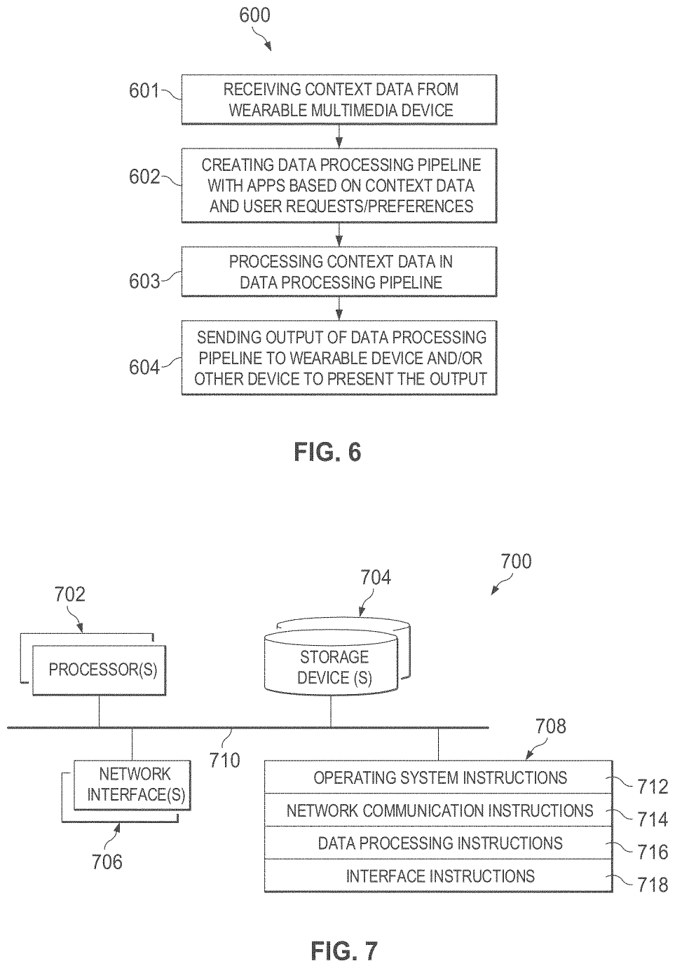

FIG. 6 is flow diagram of a data pipeline process, according to an embodiment. Process 600 can be implemented using wearable multimedia devices 101 and cloud computing platform 102 described in reference to FIGS. 1-5.

Process 600 can begin by receiving context data from a wearable multimedia device (601). For example, the context data can include video, audio and still images captured by a camera and audio subsystem of the wearable multimedia device.

Process 600 can continue by creating (e.g., instantiating) a data processing pipeline with applications based on the context data and user requests/preferences (602). For example, based on user requests or preferences, and also based on the data type (e.g., audio, video, photo), one or more applications can be logically connected to form a data processing pipeline to process the context data into a presentation to be playback on the wearable multimedia device or another device.

Process 600 can continue by processing the context data in the data processing pipeline (603). For example, speech from user commentary during a moment or transaction can be converted into text, which is then used to label objects in a video clip.

Process 600 can continue by sending the output of the data processing pipeline to the wearable multimedia device and/or other playback device (604).

### Example Cloud Computing Platform Architecture

FIG. 7 is an example architecture 700 for cloud computing platform 102 described in reference to FIGS. 1-6, according to an embodiment. Other architectures are possible, including architectures with more or fewer components. In some implementations, architecture 700 includes one or more processor(s) 702 (e.g., dual-core Intel® Xeon® Processors), one or more network interface(s) 706, one or more storage device(s) 704 (e.g., hard disk, optical disk, flash memory) and one or more computer-readable medium(s) 708 (e.g., hard disk, optical disk, flash memory, etc.). These components can exchange communications and data over one or more communication channel(s) 710 (e.g., buses), which can utilize various hardware and software for facilitating the transfer of data and control signals between components.

The term “computer-readable medium” refers to any medium that participates in providing instructions to processor(s) 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium(s) 708 can further include operating system 712 (e.g., Mac OS® server, Windows® NT server, Linux Server), network communication module 714, interface instructions 716 and data processing instructions 718.

Operating system 712 can be multi-user, multiprocessing, multitasking, multithreading, real time, etc. Operating system 712 performs basic tasks, including but not limited to: recognizing input from and providing output to devices 702, 704, 706 and 708; keeping track and managing files and directories on computer-readable medium(s) 708 (e.g., memory or a storage device); controlling peripheral devices; and managing traffic on the one or more communication channel(s) 710. Network communications module 714 includes various components for establishing and maintaining network connections (e.g., software for implementing communication protocols, such as TCP/IP, HTTP, etc.) and for creating a distributed streaming platform using, for example, Apache Kafka™. Data processing instructions 716 include server-side or backend software for implementing the server-side operations, as described in reference to FIGS. 1-6. Interface instructions 718 includes software for implementing a web server and/or portal for sending and receiving data to and from wearable multimedia devices 101, third party application developers 104 and third party platforms 105, as described in reference to FIG. 1.

Architecture 700 can be included in any computer device, including one or more server computers in a local or distributed network each having one or more processing cores. Architecture 700 can be implemented in a parallel processing or peer-to-peer infrastructure or on a single device with one or more processors. Software can include multiple software components or can be a single body of code.

### Example Wearable Multimedia Device Architecture

FIG. 8 is a block diagram of example architecture 800 for a wearable multimedia device implementing the features and processes described in reference to FIGS. 1-6. Architecture 800 may include memory interface 802, data processor(s), image processor(s) or central processing unit(s) 804, and peripherals interface 806. Memory interface 802, processor(s) 804 or peripherals interface 806 may be separate components or may be integrated in one or more integrated circuits. One or more communication buses or signal lines may couple the various components.

Sensors, devices, and subsystems may be coupled to peripherals interface 806 to facilitate multiple functions. For example, motion sensor(s) 810, biometric sensor(s) 812, and depth sensor(s) 814 may be coupled to peripherals interface 806 to facilitate motion, orientation, biometric, and depth detection functions. In some implementations, motion sensor(s) 810 (e.g., an accelerometer, rate gyroscope) may be utilized to detect movement and orientation of the wearable multimedia device.

Other sensors may also be connected to peripherals interface 806, such as environmental sensor(s) (e.g., temperature sensor, barometer, ambient light) to facilitate environment sensing functions. For example, a biometric sensor 812 can detect fingerprints, face recognition, heart rate and other fitness parameters. In an embodiment, a haptic motor (not shown) can be coupled to the peripheral interface, which can provide vibration patterns as haptic feedback to the user.

Location processor 815 (e.g., GNSS receiver chip) may be connected to peripherals interface 806 to provide geo-referencing. Electronic magnetometer 816 (e.g., an integrated circuit chip) may also be connected to peripherals interface 806 to provide data that may be used to determine the direction of magnetic North. Thus, electronic magnetometer 816 may be used by an electronic compass application.

Camera subsystem 820 and an optical sensor 822, e.g., a charged coupled device (CCD) or a complementary metal-oxide semiconductor (CMOS) optical sensor, may be utilized to facilitate camera functions, such as recording photographs and video clips. In an embodiment, the camera has a 180° FOV and OIS. The depth sensor 814 can include an infrared emitter that projects dots in a known pattern onto an object/subject. The dots are then photographed by a dedicated infrared camera and analyzed to determine depth data. In an embodiment, a time-of-flight (TOF) camera can be used resolve distance based on the known speed of light and measuring the time-of-flight of a light signal between the camera and an object/subject for each point of the image.

Communication functions may be facilitated through one or more communication subsystems 824. Communication subsystem(s) 824 may include one or more wireless communication subsystems. Wireless communication subsystems may include radio frequency receivers and transmitters and/or optical (e.g., infrared) receivers and transmitters. Wired communication systems may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data (e.g., a projector).

The specific design and implementation of the communication subsystem 824 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, IEEE802.xx communication networks (e.g., Wi-Fi, WiMax, ZigBee™), 3G, 4G, 4G LTE, code division multiple access (CDMA) networks, near field communication (NFC), Wi-Fi Direct and a Bluetooth™ network. Wireless communication subsystems may include hosting protocols such that the device may be configured as a base station for other wireless devices. As another example, the communication subsystems may allow the device to synchronize with a host device using one or more protocols or communication technologies, such as, for example, TCP/IP protocol, HTTP protocol, UDP protocol, ICMP protocol, POP protocol, FTP protocol, IMAP protocol, DCOM protocol, DDE protocol, SOAP protocol, HTTP Live Streaming, MPEG Dash and any other known communication protocol or technology.

Audio subsystem 826 may be coupled to a speaker 828 and one or more microphones 830 to facilitate voice-enabled functions, such as voice recognition, voice replication, digital recording, telephony functions and beamforming.

I/O subsystem 840 may include touch controller 842 and/or another input controller(s) 844. Touch controller 842 may be coupled to a touch surface 846. Touch surface 846 and touch controller 842 may, for example, detect contact and movement or break thereof using any of a number of touch sensitivity technologies, including but not limited to, capacitive, resistive, infrared, and surface acoustic wave technologies, as well as other proximity sensor arrays or other elements for determining one or more points of contact with touch surface 846. In one implementation, touch surface 846 may display virtual or soft buttons, which may be used as an input/output device by the user.

Other input controller(s) 844 may be coupled to other input/control devices 848, such as one or more buttons, rocker switches, thumb-wheel, infrared port, USB port, and/or a pointer device such as a stylus. The one or more buttons (not shown) may include an up/down button for volume control of speaker 828 and/or microphone 830.

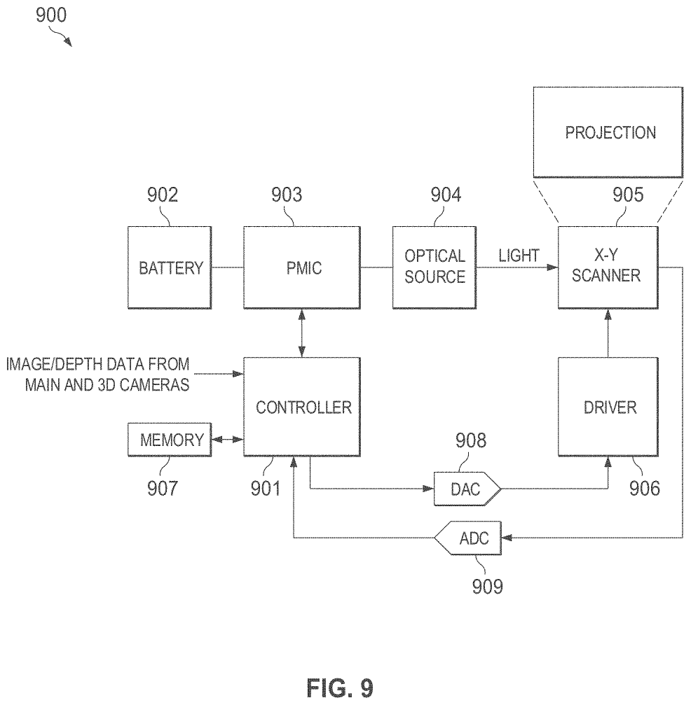

Further, a projector subsystem 832 may be connected to peripherals interface 806 to present information visually to a user in the form of projected light. The projector subsystem 832 can include the optical projector 257 of FIG. 2B. For example, the projector subsystem 832 can project light onto a surface according to a particular spatial and/or temporal pattern, such that the user perceives text, images, videos, colors, patterns, and/or any other graphical information on the surface. In some implementations, the projector subsystem 832 can project light onto a surface of the user's body, such as the user's hand or palm. In some implementations, the projector subsystem 832 can project light onto a surface other than the user's body, such as a wall, a table, a desk, or any other object. The projector subsystem 832 is described in greater detail with reference to FIG. 9.

In some implementations, the projector subsystem 832 project light onto a surface to provide an interactive virtual interface (VI) for a user. For example, the projector subsystem 832 can project light onto the surface, such that the user perceives one or more interactive user interface elements (e.g., selectable buttons, dials, switches, boxes, images, videos, text, icons, etc.). Further, the user can interact with the VI by performing one or more gestures with respect to the VI and the user interface elements. For example, the user can perform a pointing gesture, a tapping gesture, a swiping gesture, a waving gesture, or any other gesture using her hands and/or fingers. The wearable multimedia device can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804). Example VIs are described in further detail below.

In some implementations, device 800 plays back to a user recorded audio and/or video files (including spatial audio), such as MP3, AAC, spatial audio and MPEG video files. In some implementations, device 800 may include the functionality of an MP3 player and may include a pin connector or other port for tethering to other devices. Other input/output and control devices may be used. In an embodiment, device 800 may include an audio processing unit for streaming audio to an accessory device over a direct or indirect communication link.

Memory interface 802 may be coupled to memory 850. Memory 850 may include high-speed random access memory or non-volatile memory, such as one or more magnetic disk storage devices, one or more optical storage devices, or flash memory (e.g., NAND, NOR). Memory 850 may store operating system 852, such as Darwin, RTXC, LINUX, UNIX, OS X, iOS, WINDOWS, or an embedded operating system such as VxWorks. Operating system 852 may include instructions for handling basic system services and for performing hardware dependent tasks. In some implementations, operating system 852 may include a kernel (e.g., UNIX kernel).

Memory 850 may also store communication instructions 854 to facilitate communicating with one or more additional devices, one or more computers or servers, including peer-to-peer communications with wireless accessory devices, as described in reference to FIGS. 1-6. Communication instructions 854 may also be used to select an operational mode or communication medium for use by the device, based on a geographic location of the device.

Memory 850 may include sensor processing instructions 858 to facilitate sensor-related processing and functions and recorder instructions 860 to facilitate recording functions, as described in reference to FIGS. 1-6. Other instructions can include GNSS/Navigation instructions to facilitate GNSS and navigation-related processes, camera instructions to facilitate camera-related processes and user interface instructions to facilitate user interface processing, including a touch model for interpreting touch inputs.

Each of the above identified instructions and applications may correspond to a set of instructions for performing one or more functions described above. These instructions need not be implemented as separate software programs, procedures, or modules. Memory 850 may include additional instructions or fewer instructions. Furthermore, various functions of the device may be implemented in hardware and/or in software, including in one or more signal processing and/or application specific integrated circuits (ASICs).

FIG. 9 is a system block diagram 900 of the projector subsystem 832, according to an embodiment. The projector subsystem 832 scans a pixel in two dimensions, images a 2D array of pixels, or mixes imaging and scanning. Scanning projectors directly utilize the narrow divergence of optical beams, and two-dimensional (2D) scanning to “paint” an image pixel by pixel. In one embodiment, separate scanners are used for the horizontal and vertical scanning directions. In other embodiments, a single biaxial scanner is used. The specific beam trajectory also varies depending on the type of scanner used.

In the example shown, the projector subsystem 832 is a scanning pico-projector that includes controller 901, battery 902, power management chip (PMIC) 903, optical source 904, X-Y scanner 905, driver 906, memory 907 (e.g., a flash memory), digital-to-analog converter (DAC) 908 and analog-to-digital converter (ADC) 909. The optical source 904 can include a laser, e.g., a solid state laser such as a vertical-cavity surface emitting laser (VCSEL), a light-emitting diode (LED), or any other suitable light source to emit light for projection. The projector subsystem 832 is an optical projection system that can be a laser projection system with a laser as the optical source 904.

Controller 901 provides control signals to X-Y scanner 905. X-Y scanner 905 uses moveable mirrors to steer the optical beam generated by optical source 904 in two dimensions in response to the control signals. X-Y scanner 905 includes one or more micro-electromechanical (MEMS) micromirrors that have controllable tilt angles in one or two dimensions. Driver 906 includes a power amplifier and other electronic circuitry (e.g., filters, switches) to provide the control signals (e.g., voltages or currents) to X-Y scanner 905. Memory 907 stores various data used by the projector including optical patterns for text and images to be projected. DAC 908 and ADC 909 provide data conversion between digital and analog domains. PMIC 903 manages the power and duty cycle of optical source 904, including turning on and shutting of optical source 904 and adjusting the amount of power supplied to optical source 904.

In an embodiment, controller 901 uses image data from the camera/video subsystem 820 and/or depth data from the depth sensor(s) 814 to recognize and track user hand and/or finger positions on the optical projection, such that user input is received by the wearable multimedia device 101 using the optical projection as an input interface.

In another embodiment, the projector subsystem 832 uses a vector-graphic projection display and low-powered fixed MEMS micromirrors to conserve power. Because the projector subsystem 832 includes a depth sensor, the projected area can be masked when necessary to prevent projecting on a finger/hand interacting with the optically projected image. In an embodiment, the depth sensor can also track gestures to control the input on other devices (e.g., swiping through images on a TV screen, interacting with computers, smart speakers, etc.).

In other embodiments, Liquid Crystal on Silicon (LCoS or LCOS), Digital Light Processing (DLP) or Liquid Chrystal Display (LCD) digital projection technology can be used instead of a pico-projector.

### Example Projection Surfaces and Virtual Interfaces

As described above, a wearable multimedia device 101 can include a projector subsystem 832 configured to present information visually to a user in the form of projected light. The projector subsystem 832 can turn any suitable surface into a projection surface for displaying the information to the user. The projection surface can be a surface of a user's hand (e.g., the user's palm), another body part of the user (e.g., the user's arm), a wearable cloth, a screen, a wall, a table top, or any other suitable surface. The information can be a virtual object. In one embodiment, the virtual object includes one or more images or videos and/or texts. In one embodiment, the virtual object includes an interactive VI.

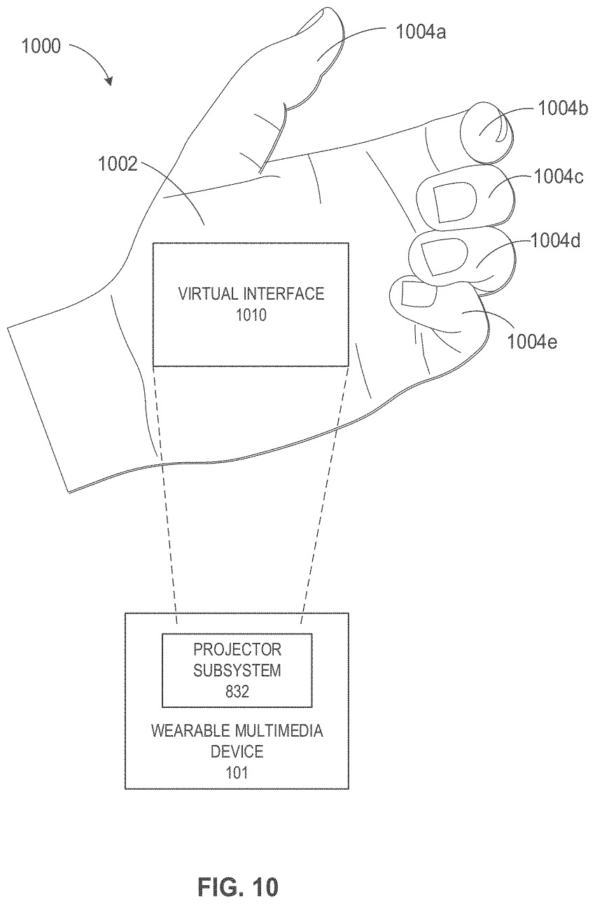

For illustration, in FIG. 10 and FIGS. 11A-11J, a user's hand 1000 (e.g., a user's palm 1002) is used as an example of a projection surface, and a VI is used as an example of a virtual object.

As shown in FIG. 10, the projector subsystem 832 can project optical signals onto a projection surface, e.g., a surface of a user's hand 1000, such as the user's palm 1002, according to a particular spatial and/or temporal pattern, such that the user perceives a VI 1010 with one or more user interface elements. In some implementations, the VI 1010 and/or the user interface elements can include any combination of text, images, videos, colors, patterns, shapes, lines, or any other graphical information.

The user can perform gestures to interact with the VI. For instance, the user can perform one or more gestures directed at one or more of the user interface elements. As examples, the user can point to a user interface element, touch or tap a user interface element using her finger (e.g., a single time, or multiple times in a sequence), perform a swiping motion along a user interface element using her finger, wave at a user interface element using her hand, hover over the user interface element, or perform any other hand or finger gesture. The wearable multimedia device 101 can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804). At least some of the user interface elements and/or commands can be used to control the operation of the wearable multimedia device 101. For example, at least some of the user interface elements and/or commands can be used to execute or control the generation of video and/or audio content, the viewing of content, the editing of content, the storing and transmission data, and/or any other operation described herein.

As illustrated in FIG. 10, the user's palm 1002 may have a limited surface area in which to project the VI 1010. This limited surface area can limit the number and types of user interactions with the VI, and thus potentially limit the number and types of applications that rely on the VI for input and output. Additionally, the hand 1000 of the user can have fingers 1004a, 1004b, 1004c, 1004d, 1004e (referred to generally as fingers 1004 or individually as finger 1004). The posture of one or more fingers 1004 and/or the palm 1002 can be straight, curved, tilted, or rotated with respect to a direction of optical projection from the projection subsystem 832, which can cause 3D variability of the projection surface and affect the projection of the VI on the projection surface.

### Example Virtual Interface Elements

In an embodiment, a system, e.g., system 250 of FIG. 2B or system 800 of FIG. 8, disclosed herein is responsive or aware of proximity resulting but not limited to finger input to VI elements on an optically projected (e.g., laser projected) display. Because depth sensor (e.g., depth sensor 252 or 814 such as a TOF camera) captures the distance, shape and volume of any input element (e.g., finger input) within its field of view (FOV) that is approaching a surface (e.g., hand, table, etc.), any resulting geometry derived from the depth image can be used with, for example, any VI elements (e.g., sound, visual or gesture). Also, distances from one hand to another hand, or one finger to another finger, or one surface to another surface can be determined and used to trigger one or more actions on the wearable multimedia device or other devices. For example, an optical projection system (e.g., optical projector 257 of FIG. 2B or the projector subsystem 832 of FIG. 8 or 9) can enlarge VI elements projected on a surface when the finger approaches the VI element based on a distance between a finger and the surface. In other embodiments, the system can adjust the entire scale of the optically projected display based on how far the projection surface is from the depth sensor. For example, as a user moves their hand away from the projection surface, text projected on the surface gets bigger while still being responsive to, e.g., the user “hovering” their hand above the text or moving one or two of their fingers together to make a payment for a transaction performed on the wearable multimedia device or other device.

FIG. 11A illustrates a “homepage” VI element for a wearable multimedia device, according to an embodiment. In this example and the examples that follow, a VI is projected onto palm 1002 of a user's left-hand 1000. Note, however, that the following VI elements can be projected onto any surface. The optical projection can be provided by, for example, a wearable multimedia device, such as the wearable multimedia device described herein using an optical projector architecture, e.g., the optical projector 257 of FIG. 2B or the projector subsystem 832 of FIG. 8 or 9.

In an embodiment, VI element 1101 can be touched by the user causing additional VI elements 1102, 1103, 1104, 1105, and 1106 to be projected on palm 1002, as shown in FIG. 11B. VI elements 1102, 1103, 1104, 1105, and 1106 appear and disappear based on interactions that have a timeout from a last meaningful interaction. In another embodiment, proximity of the user's finger or pointing device (e.g., hovering a finger over the VI element 1101) can cause additional VI elements 1102, 1103, 1104, 1105, and 1106 to be displayed. The VI elements shown in FIG. 11B are examples and more or fewer VI elements can be projected onto palm 1002. In the examples that follow, the term “select” when used in reference to a VI element includes user selection by either touch or proximity or both touch and proximity using one or more fingers and/or a pointing device (e.g., a pencil). In this example VI element 1101 is a “home screen” VI element, which the user can select whenever the user wants to clear the current optical projections from the surface and start a new interaction with the VI.

Selecting “nearby” VI element 1102 projects VI element (or icons) 1107, 1108, and 1109 for nearby landmarks, as shown in FIG. 11C. Each VI element 1104, 1105, or 1106 can be selected to reveal additional VI element(s) for various communication modalities. For example, VI element 1104 can invoke additional instant messaging VI element(s),VI element 1105 can invoke email VI element(s) and VI element 1106 can invoke additional Twitter® VI element(s). VI element 1103 invokes an application navigator, as described in reference to FIG. 11F.

FIG. 11C illustrates a VI projection after a “nearby” VI element shown in FIG. 11B has been selected by a user, according to an embodiment. In the example shown, VI elements 1107, 1108, 1109 represent three landmarks in Paris, France: Mars Commune, Eiffel Tower and the Seine river, respectively. In an embodiment, the user can select any of VI elements 1107, 1108, 1109 to get content and/or services related to the landmark, such as turn by turn directions (e.g., walking, driving, bicycle) to the landmark from the user's current location (e.g., as determined by GNSS receiver 255 of FIG. 2B or location processor 815 of FIG. 8), a compass direction (e.g., as determined by an IMU) and any other information, including but not limited to contact information for local restaurants or hotels, gas stations and the like. Although three locations are projected, any number of landmarks can be projected. User settings and/or inferred context based on sensor data, location data and maps can be used to determine which landmarks are included when the user selects VI element 1102. For example, a default can be the most popular sites based on public information, user history data or the user's specified interests. In an embodiment, user history data can include a user photo library that can be used to determine what types of landmarks the user is interested in visiting. For example, if the photo library has many pictures of rivers, then the Seine River would be selected as a landmark to be projected in the VI.

FIG. 11D illustrates a VI projection 1110 after VI element 1104 (Instant Messaging modality) has been selected by the user, according to an embodiment. In an embodiment, default text can be inserted in the text message based on the inferred context. For example, if the instant messaging session describes meeting up between friends at a particular location, an option to receive directions to the location are included in an options menu 1120, as described in reference to FIG. 11E. The inferred context can be based on previous text messages or other communication sessions, such as email, Tweets and social media posts. For example, previous text messages, emails, Tweets and any other communication session data may reference individuals, locations, businesses, products, services, weather conditions and other textual clues regarding the context of the communication session. This text is parsed and analyzed to infer context. In an embodiment, a machine learning model receives samples of the parsed text and is trained to infer/predict the context of a communication session.

FIG. 11E illustrates VI elements presenting various options for selection by the user, according to an embodiment. In the example shown, context sensitive options menu 1120 is projected on palm 1002 in response to a VI element being selected. Context sensitive options menu 1120 can include any desired option suitable for the particular context that has been inferred. In the example, shown the options menu includes calling a contact “Oliver”, directions to a particular location (e.g., directions to a location to meet Oliver) and sharing (e.g., sending directions to Oliver). More or fewer options can be included in options menu 1120, and any number of option menus can be included in the VI, including options menus that are not context sensitive.

FIG. 11F illustrates a VI projection presenting a VI element 1130 for launching applications, according to an embodiment. In the example shown, VI element 1130 is invoked by the user selecting VI element 1103, and includes two concentric rings with nodes embedded in the rings corresponding to applications. For example, the inner ring includes nodes for music, talk, calendar and time. Selecting any of these nodes will invoke the corresponding application. For example, touching the “talk” node causes VI element 1140 to be projected, as shown in FIG. 11G.

The outer ring also includes nodes corresponding to applications. For example, the outer ring includes nodes for health, camera, navigation, news, electronic payment, contacts/people, social media and recall. In an embodiment, nodes that correspond to applications that are most relevant to a current inferred context are modified (e.g., magnified) to provide the user with a visual indication of their relevance to the current context. In the example shown, the nodes scale (increase in size or magnify) based on what is most relevant to the user in the moment (e.g., notifications, time, location, etc.).

In the example shown, the Health node is scaled to indicate that the Health application is most relevant in the moment (e.g., relevant to the current context). In this example, the current context can be that the user is engaged in a fitness activity. This can be inferred from sensor data, such as motion data from accelerometers and angular rate sensors. In an embodiment, step count from a digital pedometer on the wearable multimedia device can be used to infer the user is engaged in a physical activity, and therefore may be interested in running the Health application. The Health application can track user fitness activity (e.g., counting steps) and any other desired health monitoring.

In alternative embodiments, rather the concentric circles other concentric polygon shapes can be used, such as concentric squares, concentric, triangles, concentric rectangles, etc. In some embodiments, nodes are arranged along an open curve having any desired shape. In an embodiment, projections are made on one or more fingers. In an embodiment, the VI changes, is projected or removed based on one or more inputs other than touch or proximity touch inputs, such as, for example, responding to one or more voice commands, and responding to hand gestures, including but not limited to fist clenching, hand waiving, finger positions (e.g., relative distance between fingers) etc.

FIG. 11G illustrates a VI projection 1140 presented after the user selects the “talk” application shown in FIG. 11F, according to an embodiment. Example VI elements shown include VI element 1142 for making an Internet phone call (e.g., using VoIP technology) and VI element 1143 for composing and sending an email.

FIG. 11H illustrates a VI projection 1150 for an email application with a send email virtual button selected, according to an embodiment. In an embodiment, emails can be composed verbally (e.g., using microphones and speech recognition stack) or through an optically projected virtual keyboard projected on a surface (e.g., projected on a desk surface). A default message can be included in the email that is composed based on an inferred context. In the example shown, an email is sent from Imran to Parker. A default message is inserted: “It's been a while! Want to grab sushi next Thursday.” The default message can be inferred based on context data obtained from various applications on the wearable multimedia device. For example, based on Imran's contact list and his calendar, the system can infer that Parker is a friend of Imran for which there has not been any communication for a specified period of time (e.g., based on examination of historical emails, text messages phone calls, etc.), and that Thursday is open for Imran based on Imran's calendar data. The system may also know that Imran eats sushi regularly (or sushi was specified by Imran as a favorite cuisine), and/or the last time Imran had lunch with Parker it was at a sushi restaurant (e.g., inferred based on email and/or calendar data).

FIG. 11I illustrates a VI projection 1152 for the email application shown in FIG. 11H with an edit email virtual button selected, according to an embodiment. After the default message is projected, the user can select an edit virtual button to project an email edit interface that will allow the user to edit the email using, for example, touch/proximity gestures.

FIG. 11J illustrates a VI projection 1154 for the email application shown in FIG. 11I with the edit email option selected and showing editing options, according to an embodiment. In an embodiment, context sensitive options are presented in email edit mode. In this example, options for casual or formal dining are projected. For example, Parker may be either a friend or business contact/client, so Imran has the option of choosing a formal, full service Japanese restaurant over a casual sushi restaurant.

Although FIGS. 11H-11I are directed to an email application, the VI elements and features shown can be used with any communication modality, such as text messages, Tweets and social media postings.

### Example Adjustments

A VI to be projected, e.g., the VI as described in any one of FIGS. 11A to 11J, can be a two-dimensional (2D) image. If the 2D image is directly projected onto a projection surface having 3D variability (e.g., having an uneven or non-flat surface) the user may see distortion(s) of the 2D image across the projection surface. For example, a part at a higher region of the projection surface may appear larger to the user, while a part at a lower region of the projection surface may appear smaller to the user. If the 2D image is projected with a same magnification ratio, on the projection surface, the appearing-larger part and the appearing-smaller part may form a distorted projected 2D image to the user.

To compensate or eliminate the distortion or any other distortions such that a projected virtual object appears undistorted, as described above and below with details, a wearable multimedia device can first determine a 3D map of a projection surface based on sensor data of at least one sensor of the wearable multimedia device, then determine a distortion associated with the virtual object to be projected by an optical projection system (e.g., the optical projector 257 of FIG. 2B or the projection subsystem 832 of FIG. 8 or 9) on the projection surface, and then adjust, based on the determined distortion, at least one of (i) one or more characteristics of the virtual object to be projected, or (ii) the optical projection system.

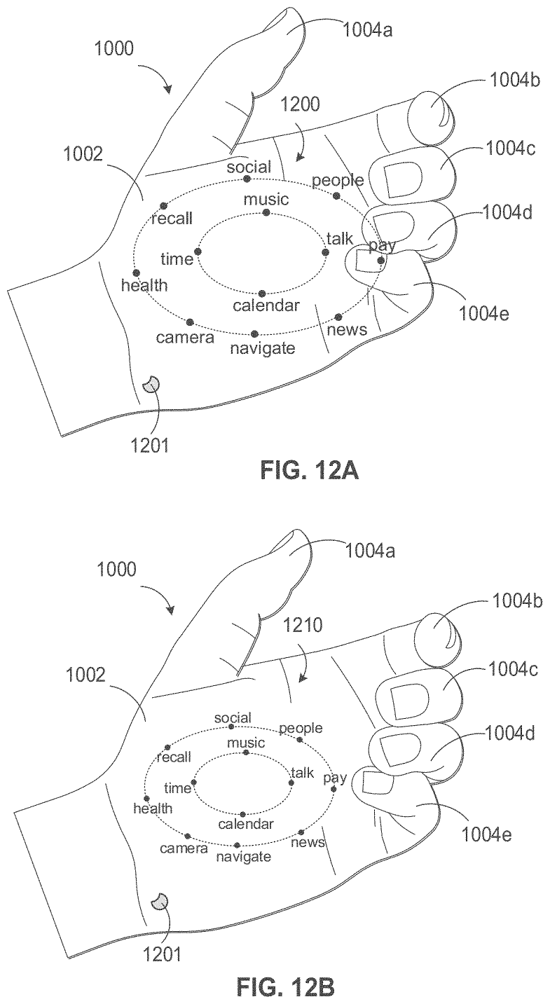

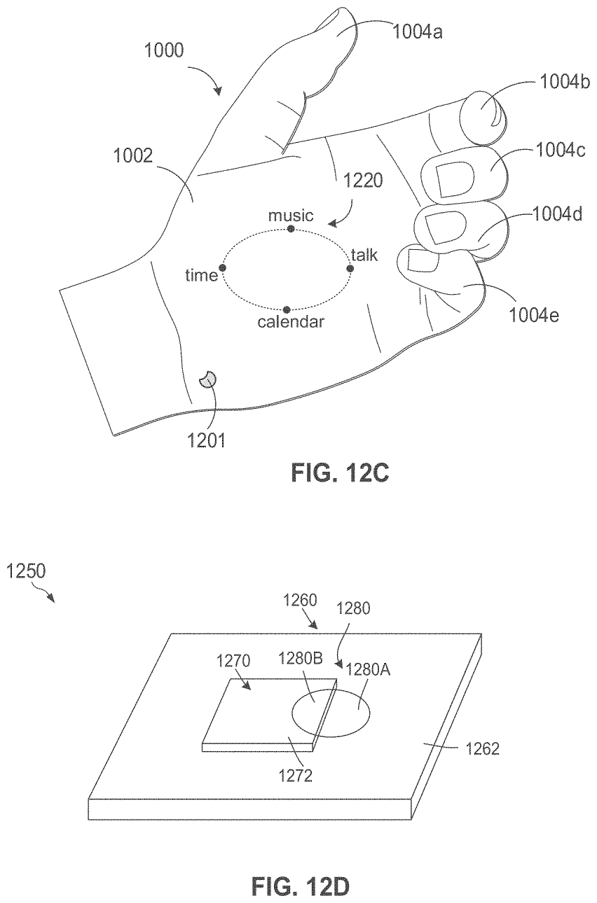

In one embodiment, as illustrated in FIGS. 12A-12B, the wearable multimedia device can globally adjust the one or more characteristics of the virtual object to be projected, e.g., a magnification ratio, a resolution, a stretching ratio, a shrinking ratio, or a rotation angle. In one embodiment, as illustrated in FIG. 12C, the wearable multimedia device can adjust content of the virtual object to be projected on the projection surface, e.g., showing more or less content based on more or less available flat surface area of the projection surface. In one embodiment, as illustrated in FIG. 12D, the wearable multimedia device can individually or locally adjust the one or more characteristics of the virtual object to be projected based on uneven regions of the projection surface.

Referring to FIG. 12A, a VI projection presenting VI elements 1200 for launching applications on a user's hand 1000. A VI element 1201 can be touched by the user to cause the VI elements 1200 to be projected on the user's hand 1000. The VI element 1201 can be a “home screen” VI element, e.g., the VI element 1101, which the user can select whenever the user wants to clear the current optical projections from the surface and start a new interaction with the VI.

In one embodiment, the VI elements 1200 are similar to the VI elements 1130 of FIG. 11F, and include two concentric rings with nodes embedded in the rings corresponding to applications. For example, the inner ring includes nodes for “music,” “talk,” “calendar” and “time.” Selecting any of these nodes can invoke the corresponding application. The outer ring also includes nodes corresponding to applications. For example, the outer ring includes nodes for “health,” “camera,” “navigation,” “news,” “electronic payment,” “people (or contacts),” “social media” and “recall.” In an embodiment, nodes that correspond to applications that are most relevant to a current inferred context can be modified (e.g., magnified) to provide the user with a visual indication of their relevance to the current context.

In alternative embodiments, rather the concentric circles other concentric polygon shapes can be used, such as concentric squares, concentric, triangles, concentric rectangles, etc. In one embodiment, nodes are arranged along an open curve having any desired shape. In an embodiment, projections are made on one or more fingers. In an embodiment, the VI changes, is projected or removed based on one or more inputs other than touch or proximity touch inputs, such as, for example, responding to one or more voice commands, and responding to hand gestures, including but not limited to fist clenching, hand waiving, finger positions (e.g., relative distance between fingers) etc.

As illustrated in FIG. 12A, due to the curved fingers (e.g., 1004c, 1004d, 1004e), the user's hand 1000 provides a less flat area to present a virtual image including the VI elements 1200 and 1201. Part of the virtual image (e.g., node “pay”) is projected not on the user's palm 1002, but on a curved finger 1004e.

To avoid the distortion caused by the uneven projection surface of the user's hand 1000, the wearable multimedia device can globally adjust the virtual image including the VI elements 1200 and 1201, e.g., decreasing the magnification ratio of the virtual image or shrinking the virtual image, such that an adjusted virtual image 1210 is projected on the user's palm with a relatively flat surface area, as illustrated in FIG. 12B.

In another embodiment, instead of adjusting the virtual image, the optical projection system can be moved relative to the projection surface, or the optical projection from the optical projection system can be tilted or rotated with an angle. In one example, if the virtual object to be projected has an estimated projection area that is greater than that of the projection surface, the optical projection system can be moved closer to the projection surface, such that the virtual object can be projected within the projection surface, e.g., as illustrated in FIG. 12B. In another example, if the projection surface has a slope with respect to the optical projection, the optical projection can be titled with a corresponding angle such that the titled optical projection is perpendicular to the projection surface.

In another embodiment, instead of globally adjusting the virtual image, the wearable multimedia device can adjust content of the virtual object to be projected on the projection surface. For example, as illustrated in FIG. 12C, a projected virtual image 1220 only includes the inner ring of the virtual elements 1200 that has nodes for “music,” “talk,” “calendar” and “time.” The inner ring can be projected without adjustment (e.g., shrinking or stretching). In one embodiment, instead of projecting the inner ring, the outer ring of the virtual elements 1200 can be selected to be projected with some adjustment (e.g., shrinking to be projected on the user's palm 1002). The wearable multimedia device can determine to present the inner ring or the outer ring based on a current context associated with the user. For example, the current context can be that the user is engaged in a fitness activity, which can be inferred from sensor data, such as motion data from accelerometers and angular rate sensors. In an embodiment, step count from a digital pedometer on the wearable multimedia device can be used to infer the user is engaged in a physical activity, and therefore may be interested in running the Health application. The Health application can track user fitness activity (e.g., counting steps) and any other desired health monitoring. Thus, the wearable multimedia device can determine to present the outer ring including node “health.” In one embodiment, instead of choosing between the inner ring and the outer ring to be projected, one or more nodes in the inner ring or the outer ring can be changed based on the current content. For example, node “health” can be moved to the inner ring, e.g., in replacement of node “time”, to be projected on the user's palm.

FIG. 12D is a diagram 1250 of an example optical projection of a virtual object on an uneven projection surface. The wearable multimedia device can individually or locally adjust the one or more characteristics of the virtual object to be projected based on uneven regions of the projection surface. The virtual object can be a 2D image.

In one example, the uneven projection surface includes a first surface 1262 on a first object 1260 (e.g., a table) and a second surface 1272 on a second object 1270 (e.g., a book on the table). A direction of optical projection from an optical projection system can be perpendicular to the first surface 1262 and the second surface 1272. Thus, with respect to the optical projection, the first surface 1262 has a greater depth than the second surface 1272. Due to divergence of the optical projection, a first section 1280A of the 2D image to be projected on the first surface 1262 can appear smaller than a second section 1280B of the 2D image to be projected on the second surface 1272.

To eliminate the distortion and maintain a consistent and undistorted projected 2D image, the wearable multimedia device can individually or locally increase a magnification ratio of the first section 1280A and/or decrease a magnification ratio of the second section 1280B before projecting the 2D image onto the first surface 1262 and the second surface 1272, such that a projected 2D image 1280 includes the projected first section 1280A and the projected second section 1280B that appear to a user with a same magnification ratio.

### Example Operations

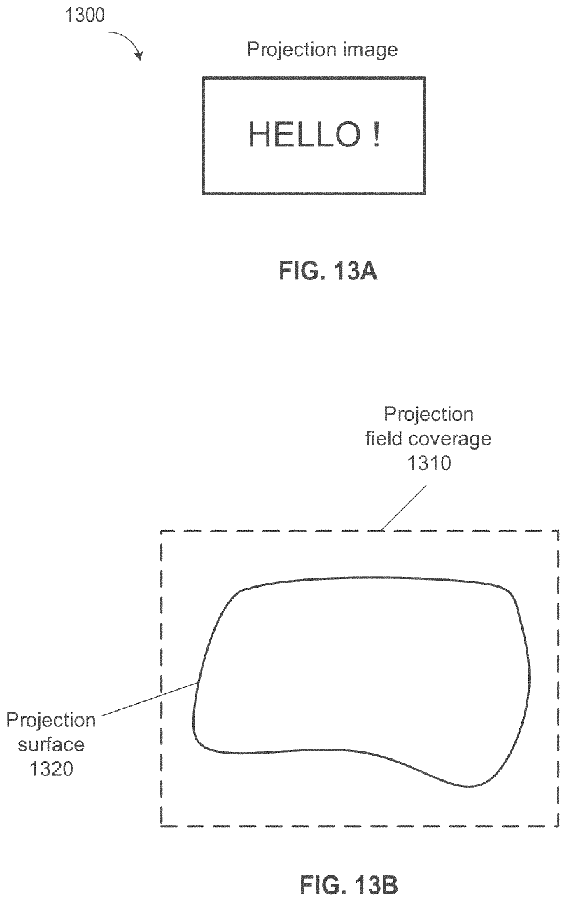

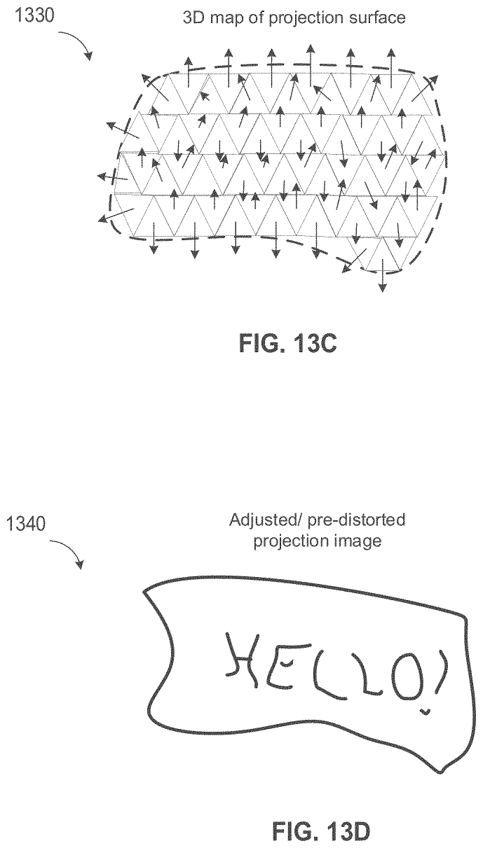

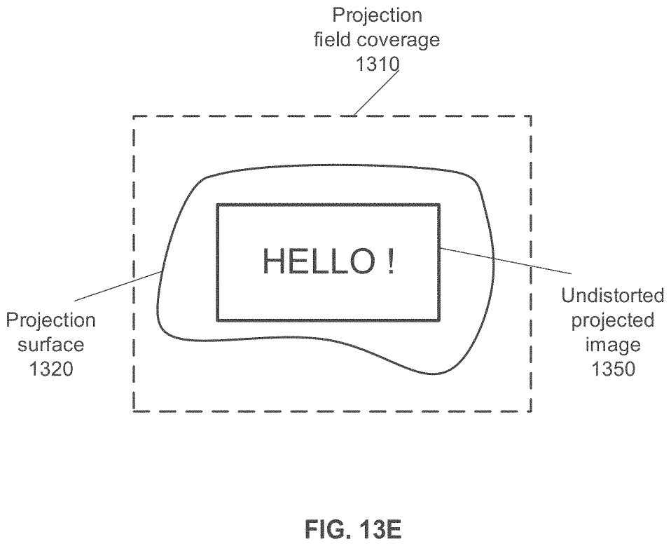

FIGS. 13A-13E are diagrams of example operations relating to managing optical projection with a wearable multimedia device, according to an embodiment. The operations can be implemented using a wearable multimedia device, e.g., the wearable multimedia device 101 described in reference to FIGS. 1-12D. The wearable multimedia device includes an optical projection system, e.g., the optical projector 257 of FIG. 2B or the projection subsystem 832 described in reference to FIGS. 8-12D. The wearable multimedia device can locally adjust different sections of the virtual object to be projected based on corresponding different regions of the projection surface. The example operations can be implemented for each update or refresh of a projection image, or for changes of the optical projection system or the projection surface.

First, a current projection image to be projected is obtained. The projection image can be a dynamic image, e.g., a video frame, or a static image, e.g., a graphical user interface (GUI) like the VI 1010. As illustrated in FIG. 13A, a projection image 1300 is a static image including text “HELLO!” in a text box.

Second, in response to obtaining the projection image to be projected, the wearable multimedia device can prepare or present a projection surface for the projection image. A field of coverage of the optical projection system can be first determined, and then, a relative position between the optical projection system (e.g., optical projection from the optical projection system) and the projection surface can be adjusted, e.g., by controlling a scanner 905, to accommodate the projection surface within the field of coverage of the optical projection system. For example, as illustrated in FIG. 13B, a projection surface 1320 is within a projection field coverage 1310 of the optical projection system.

Third, a 3D map of the projection surface is determined. The wearable multimedia device can use sensor data of one or more sensors (e.g., radar, lidar, TOF sensor, or multiple camera sensors) to map in real-time dynamic 3D variability of the projection surface (e.g., depths, angles, among others). The wearable multimedia device can process, using a 3D mapping algorithm, the sensor data to obtain 3D mapping data for the 3D map of the projection surface. The 3D mapping algorithm can include point clouding, 3D profiling, or any other suitable 3D mapping technique. For example, FIG. 13C shows a 3D map 1330 of the projection surface 1320, where the projection surface 1320 is divided into a plurality of regions. Each region has its respective characteristics including depths and angles. Each region can have a corresponding surface that is substantially flat.

Fourth, the projection image is adjusted or pre-distorted based on the 3D map of the projection surface. The adjustment or pre-distortion can involve stretching, shrinking, rotation, or any suitable operation, to translate the projection image onto the 3D map of the projection surface to remove distortions that are caused by projecting the 2D projection image onto the 3D projection surface. The wearable multimedia device can perform the adjustment or pre-distortion operation by texture mapping or any localized mapping technique. For example, the projection image can be divided into a plurality of sections according to the plurality of regions of the projection surface, and each section of the projection image corresponds to a respective region on which the section is to be projected by the optical projection system, and then the section of the projection image can be adjusted or pre-distorted based on information of the respective region of the projection surface. FIG. 13D shows an example adjusted/pre-distorted projection image 1340 after the projection image 1300 is adjusted or pre-distorted based on the 3D map 1330 of the projection surface.

Fifth, the adjusted/pre-distorted projection image is projected by the optical projection system onto the projection surface. As the projection image is adjusted or pre-distorted based on the 3D map of the projection surface, the 3D variability of the projection surface is compensated by the adjustment or pre-distortion of the projection image, such that the projection image projected on the projection surface appears undistorted. For example, as illustrated in FIG. 13E, the adjusted/pre-distorted projection image 1340 is projected on the projection surface 1320 in the projection field coverage 1310, and a projected image 1350 appears undistorted.

### Example Processes

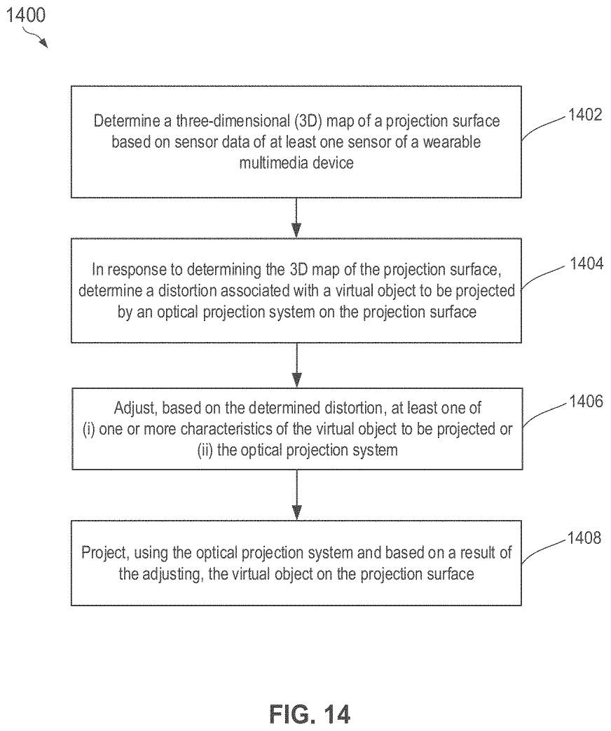

FIG. 14 is flow diagram of a process 1400 for managing optical projection with a wearable multimedia device, according to an embodiment. In some embodiments, the process 1400 is performed using a wearable multimedia device, e.g., the wearable multimedia device 101 described in reference to FIGS. 1-13E. The wearable multimedia device includes an optical projection system, e.g., the optical projector 257 of FIG. 2B or the projection subsystem 832 described in reference to FIGS. 8-13E.

In the process 1400, a 3D map of a projection surface is determined based on sensor data of at least one sensor of the wearable multimedia device (1402). For example, the at least one sensor of the wearable multimedia device can include: an accelerometer, a gyroscope, a magnetometer, a depth sensor (e.g., 252 of FIG. 2B or 814 of FIG. 8), a motion sensor (e.g., 810 of FIG. 8), a radar, a lidar, a TOF sensor, an optical sensor (e.g., 822 of FIG. 8), or one or more camera sensors (e.g., 820 of FIG. 8). The sensor data can include at least one of: variable depths of the projection surface, a movement of the projection surface, a motion of the optical projection system, or a non-perpendicular angle of the projection surface with respect to a direction of optical projection of the optical projection system.

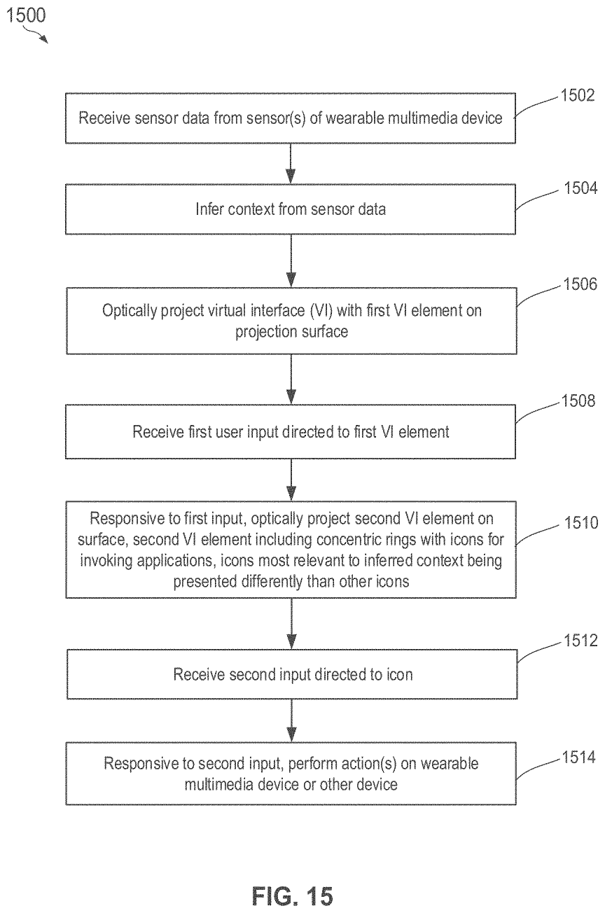

In one embodiment, the process 1400 includes: obtaining a virtual object to be projected and in response to obtaining the virtual object to be projected, presenting the projection surface for the virtual object to be projected. The virtual object includes at least one of: one or more images, texts, or videos, or a virtual interface including at least one of one or more user interface elements or content information. For example, the virtual object can be a static image, e.g., the projection image 1300 of FIG. 13A, the VI 1010 of FIG. 10, the VI of any one of FIGS. 11A to 11J, or the VI 1200 of FIG. 12A, or a dynamic image, e.g., a video frame. The VI can be obtained as described with further details in FIG. 15.

In one embodiment, the virtual object includes one or more concentric rings with a plurality of nodes embedded in each ring, each node representing an application, e.g., as illustrated in FIG. 11F.

In one embodiment, the process 1400 further includes: detecting, based on second sensor data from the at least one sensor, a user input selecting a particular node of the plurality of nodes of at least one of the one or more concentric rings through touch or proximity, and responsive to the user input, causing invocation of an application corresponding to the selected particular node, e.g., as illustrated in FIG. 11G. For example, the wearable multimedia device can utilize a camera or a depth sensor (e.g., LiDAR or TOF) for gesture recognition and control. The camera can detect and recognize hand and finger poses (e.g., finger pointing direction in 3D space). The camera image is processed using computer vision and/or machine learning models to estimate or predict/classify/annotate 2D or 3D bounding boxes of detected objects in the image.

In one embodiment, the process 1400 further includes: inferring context based on second sensor data from the at least one sensor of the wearable multimedia device, and generating, based on the inferred context, a first virtual interface (VI) with one or more first VI elements to be projected on the projection surface. The virtual object includes the first VI with the one or more first VI elements.

In one embodiment, the process 1400 includes: projecting, using the optical projection system, the first VI with the one or more first VI elements on the projection surface (e.g., as illustrated in FIG. 11B), receiving a user input directed to a first VI element of the one or more first VI elements (e.g., 1103 of FIG. 11B or 11C), and responsive to the user input, generating a second VI (e.g., 1130 of FIG. 11F) that includes one or more concentric rings with icons for invoking corresponding applications, one or more icons (e.g., “people”, “health”, or “navigate” in FIG. 11F) more relevant to the inferred context being presented differently than one or more other icons (e.g., “social”, “music”, “talk” of in FIG. 11F). The virtual object includes the second VI with the one or more concentric rings with the icons.

For example, as illustrated in FIG. 11F, the Health node is scaled to indicate that the Health application is most relevant in the moment (e.g., relevant to the current context). The current context can be that the user is engaged in a fitness activity. The current content can be inferred from the second sensor data, such as motion data from accelerometers and angular rate sensors. In an embodiment, step count from a digital pedometer on the wearable multimedia device can be used to infer the user is engaged in a physical activity, and therefore may be interested in running the Health application. The Health application can track user fitness activity (e.g., counting steps) and any other desired health monitoring.

In one embodiment, to present the projection surface for the virtual object, the process 1400 includes: determining a field of coverage of the optical projection system and adjusting a relative position between the optical projection system and the projection surface to accommodate the projection surface within the field of coverage of the optical projection system, e.g., as illustrated in FIG. 13B.

In one embodiment, the 3D map of the projection surface can be determined by processing, using a 3D mapping algorithm, the sensor data of the at least one sensor of the wearable multimedia device to obtain 3D mapping data for the 3D map of the projection surface. The 3D mapping algorithm can include point clouds, 3D profiling, or any suitable mapping technique. For example, as illustrated in FIG. 13C, the 3D map of the projection surface can include a plurality of regions. Each region can have its respective characteristics including depths and angles. Each region can have a corresponding surface that is substantially flat.

In one embodiment, the process 1400 includes: dynamically updating the 3D map of the projection surface based on updated sensor data of the at least one sensor.

The process 1400 continues by determining a distortion associated with the virtual object to be projected by the optical projection system on the projection surface, in response to determining the 3D map of the projection surface (1404). The process 1400 then adjusts, based on the determined distortion, at least one of (i) one or more characteristics of the virtual object to be projected, or (ii) the optical projection system (1406).

In one embodiment, the adjusting includes: compensating the determined distortion to make the virtual object projected on the projection surface appear to be substantially same as the virtual object projected on a flat two-dimensional (2D) surface.

In one embodiment, the distortion is determined by estimating a projection of the virtual object on the projection surface prior to projecting the virtual object on the projection surface and determining the distortion based on a comparison between the virtual object to be projected and the estimated projection of the virtual object.

In one embodiment, the distortion is determined by comparing the 3D map of the projection surface with a flat 2D surface that is orthogonal to an optical projection direction of the optical projection system, and determining the distortion associated with the virtual object to be projected on the projection surface based on a result of the comparing. The 3D map can include one or more uneven regions relative to the flat 2D surface.

In one embodiment, the distortion is determined by determining one or more sections of the virtual object to be projected on the one or more uneven regions of the projection surface. The one or more characteristics of the one or more sections of the virtual object to be projected can be locally adjusted based on information about the one or more uneven regions of the projection surface, e.g., as illustrated in FIG. 12D.

In one embodiment, the distortion is determined by segmenting the projection surface into a plurality of regions based on the 3D map of the projection surface (e.g., as illustrated in FIG. 13C), dividing the virtual object into a plurality of sections according to the plurality of regions of the projection surface, and determining the distortion associated with the virtual object based on information of the plurality of regions of the projection surface and information of the plurality of sections of the virtual object. Each of the plurality of regions can include a corresponding surface that is substantially flat. Each section of the plurality of sections of the virtual object can correspond to a respective region on which the section of the virtual object is to be projected by the optical projection system.

In one embodiment, the process 1400 includes: locally adjusting one or more characteristics of each of the plurality of sections of the virtual object to be projected based on the information about the plurality of regions of the projection surface and the information about the plurality of sections of the virtual object. For example, FIG. 13D shows an adjusted/pre-distorted projection image 1340 based on the 3D map of the projection surface shown in FIG. 13C.

In one embodiment, the virtual object can locally adjusted by mapping each section of the plurality of sections of the virtual object to the respective region of the plurality of regions of the projection surface using a content mapping algorithm and generating the adjusted/pre-distorted virtual object by inversing the mapped sections on the respective regions. The content mapping algorithm can include texture mapping.

In one embodiment, based on the determined distortion, the optical projection system can be moved relative to the projection surface, or the optical projection from the optical projection system can be tilted or rotated with an angle. In one example, if the virtual object to be projected has an estimated projection area that is greater than that of the projection surface, the optical projection system can be moved closer to the projection surface, such that the virtual object can be projected within the projection surface, e.g., as illustrated in FIGS. 12A-12B. In another example, if the projection surface has a slope with respect to the optical projection, the optical projection can be titled with a corresponding angle such that the titled optical projection is perpendicular to the projection surface.

In one embodiment, based on the determined distortion, a content of the virtual object to be projected on the projection surface can be adjusted. For example, if the projection surface has a larger surface area, more content of the virtual object to be projected on the projection surface can be presented; if the projection surface has a smaller surface area, less content of the virtual object to be projected on the projection surface can be presented, e.g., as illustrated in FIGS. 12A and 12C.

In one embodiment, the one or more characteristics of the virtual object include at least one of: a magnification ratio, a resolution, a stretching ratio, a shrinking ratio, or a rotation angle.

The process 1400 continues by projecting, using the optical projection system and based on a result of the adjusting, the virtual object on the projection surface (1408). As the virtual object and/or the optical projection system are adjusted based on the distortion or the 3D map of the projection surface, the projected virtual object on the projection surface can appear undistorted and consistent, e.g., as illustrated in FIG. 12B, 12C, or 13E.

In one embodiment, the process 1400 further includes: capturing, by a camera sensor of the wearable multimedia device, an image of the projected virtual object on the projection surface; and determining the distortion associated with the virtual object at least partially based on the captured image of the projected virtual object on the projection surface.

FIG. 15 is a flow diagram of a process 1500 of generating VI projections, according to an embodiment. The process 1500 can be implemented using a wearable multimedia device, e.g., the wearable multimedia device 101 described in reference to FIGS. 1-13E. The wearable multimedia device includes an optical projection system, e.g., the optical projector 257 of FIG. 2B or the projection subsystem 832 described in reference to FIGS. 8-13E.

The process 1500 includes steps of receiving sensor data from sensor(s) of a wearable multimedia device (1502), inferring context from the sensor data (1504), optically projecting a virtual interface (VI) with a first VI element on a surface (1506) (e.g., a palm of a user's hand) and receiving a first user input (e.g., touch or hover) directed to the first element (1508). Responsive to the first input, the process 1500 continues by optically projecting a second VI element in the VI projected on the surface, the second VI element including multiple concentric rings with nodes embedded in each ring, each node corresponding to an application, where nodes corresponding to applications most relevant to the inferred context are projected differently (e.g., magnified, colored, highlighted, higher intensity, animated) than other nodes in the rings (1510). The process 1500 continues by receiving a second user input directed to the second VI element (1512). Responsive to the second user input, the process 1500 causes action(s) (e.g., invoking the corresponding application) to be performed on the wearable multimedia device and/or another device (1514).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor. Method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

One or more features or steps of the disclosed embodiments may be implemented using an Application Programming Interface (API). An API may define one or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method using a wearable multimedia device, the computer-implemented method comprising:
determining a three-dimensional (3D) map of a projection surface based on sensor data of at least one sensor of the wearable multimedia device;
in response to determining the 3D map of the projection surface, determining a distortion associated with a virtual object to be projected by an optical projection system on the projection surface;
adjusting, based on the determined distortion, at least one of (i) one or more characteristics of the virtual object to be projected, or (ii) the optical projection system; and
projecting, using the optical projection system and based on a result of the adjusting, the virtual object on the projection surface.

2. The computer-implemented method of claim 1, further comprising:
in response to obtaining the virtual object to be projected, presenting the projection surface for the virtual object to be projected.

3. The computer-implemented method of claim 2, wherein presenting the projection surface for the virtual object to be projected comprises:
determining a field of coverage of the optical projection system; and
in response to determining the field of coverage of the optical projection system, adjusting a relative position between the optical projection system and the projection surface to accommodate the projection surface within the field of coverage of the optical projection system.

4. The computer-implemented method of claim 1, wherein determining a three-dimensional (3D) map of a projection surface based on sensor data of at least one sensor of the wearable multimedia device comprises:
processing, using a 3D mapping algorithm, the sensor data of the at least one sensor of the wearable multimedia device to obtain 3D mapping data for the 3D map of the projection surface.

5. The computer-implemented method of claim 1, wherein adjusting, based on the determined distortion, at least one of (i) one or more characteristics of the virtual object to be projected, or (ii) the optical projection system comprises:
compensating the distortion to make the virtual object projected on the projection surface appear to be substantially same as the virtual object projected on a flat two-dimensional (2D) surface.

6. The computer-implemented method of claim 1, wherein determining the distortion associated with the virtual object to be projected on the projection surface comprises:
comparing the 3D map of the projection surface with a flat 2D surface that is orthogonal to an optical projection direction of the optical projection system, wherein the 3D map comprises one or more uneven regions relative to the flat 2D surface; and
determining the distortion associated with the virtual object to be projected on the projection surface based on a result of the comparing.

7. The computer-implemented method of claim 6, wherein determining the distortion associated with the virtual object to be projected on the projection surface comprises:
determining one or more sections of the virtual object to be projected on the one or more uneven regions of the projection surface, and
wherein adjusting, based on the determined distortion, at least one of (i) one or more characteristics of the virtual object to be projected, or (ii) the optical projection system comprises: locally adjusting the one or more characteristics of the one or more sections of the virtual object to be projected based on information about the one or more uneven regions of the projection surface.

8. The computer-implemented method of claim 1, wherein determining the distortion associated with the virtual object to be projected on the projection surface comprises:
segmenting the projection surface into a plurality of regions based on the 3D map of the projection surface, each of the plurality of regions comprising a corresponding surface that is substantially flat;
dividing the virtual object into a plurality of sections according to the plurality of regions of the projection surface, each section of the plurality of sections of the virtual object corresponding to a respective region on which the section of the virtual object is to be projected by the optical projection system; and
determining the distortion associated with the virtual object based on information of the plurality of regions of the projection surface and information of the plurality of sections of the virtual object.

9. The computer-implemented method of claim 8, wherein adjusting, based on the determined distortion, at least one of (i) one or more characteristics of the virtual object to be projected, or (ii) the optical projection system comprises:
locally adjusting one or more characteristics of each of the plurality of sections of the virtual object to be projected based on the information about the plurality of regions of the projection surface and the information about the plurality of sections of the virtual object.

10. The computer-implemented method of claim 9, wherein locally adjusting one or more characteristics of each of the plurality of sections of the virtual object to be projected comprises:
for each section of the plurality of sections of the virtual object to be projected,
mapping the section to the respective region of the plurality of regions of the projection surface using a content mapping algorithm; and
adjusting the one or more characteristics of the section based on the mapped section on the respective region.

11. The computer-implemented method of claim 1, wherein determining the distortion associated with the virtual object to be projected on the projection surface comprises:
estimating a projection of the virtual object on the projection surface prior to projecting the virtual object on the projection surface; and
determining the distortion based on a comparison between the virtual object to be projected and the estimated projection of the virtual object.

12. The computer-implemented method of claim 1, wherein the one or more characteristics of the virtual object comprise at least one of: a magnification ratio, a resolution, a stretching ratio, a shrinking ratio, or a rotation angle.

13. The computer-implemented method of claim 1, wherein adjusting, based on the determined distortion, at least one of (i) one or more characteristics of the virtual object to be projected, or (ii) the optical projection system comprises at least one of:
adjusting a distance between the optical projection system and the projection surface, or
tilting or rotating an optical projection from the optical projection system relative to the projection surface.

14. The computer-implemented method of claim 1, wherein adjusting, based on the determined distortion, at least one of (i) one or more characteristics of the virtual object to be projected, or (ii) the optical projection system comprises:
adjusting content of the virtual object to be projected on the projection surface.

15. The computer-implemented method of claim 14, wherein adjusting content of the virtual object to be projected on the projection surface comprises one of:
in response to determining that the projection surface has a larger surface area, increasing an amount of content of the virtual object to be projected on the projection surface, or
in response to determining that the projection surface has a smaller surface area, decreasing the amount of content of the virtual object to be projected on the projection surface.

16. The computer-implemented method of claim 1, comprising:
capturing, by a camera sensor of the wearable multimedia device, an image of the projected virtual object on the projection surface; and
determining the distortion associated with the virtual object at least partially based on the captured image of the projected virtual object on the projection surface.

17. The computer-implemented method of claim 1, wherein the sensor data comprises at least one of:
variable depths of the projection surface,
a movement of the projection surface,
a motion of the optical projection system, or
a non-perpendicular angle of the projection surface with respect to a direction of an optical projection of the optical projection system.

18. The computer-implemented method of claim 1, wherein the at least one sensor of the wearable multimedia device comprises:
at least one of an accelerometer, a gyroscope, a magnetometer, a depth sensor, a motion sensor, a radar, a lidar, a time of flight (TOF) sensor, or one or more camera sensors.

19. The computer-implemented method of claim 1, comprising:
dynamically updating the 3D map of the projection surface based on updated sensor data of the at least one sensor.

20. The computer-implemented method of claim 1, wherein the virtual object comprises at least one of:
one or more images, texts, or videos, or
a virtual interface including at least one of one or more user interface elements or content information.

21. The computer-implemented method of claim 1, wherein the virtual object comprises one or more concentric rings with a plurality of nodes embedded in each ring, each node representing an application, and
wherein the computer-implemented method further comprises:
detecting, based on second sensor data from the at least one sensor, a user input selecting a particular node of the plurality of nodes of at least one of the one or more concentric rings through touch or proximity; and
responsive to the user input, causing invocation of an application corresponding to the selected particular node.

22. The computer-implemented method of claim 1, further comprising:
inferring context based on second sensor data from the at least one sensor of the wearable multimedia device; and
generating, based on the inferred context, a first virtual interface (VI) with one or more first VI elements to be projected on the projection surface,
wherein the virtual object comprises the first VI with the one or more first VI elements.

23. The computer-implemented method of claim 22, comprising:
projecting, using the optical projection system, the first VI with the one or more first VI elements on the projection surface;
receiving a user input directed to a first VI element of the one or more first VI elements; and
responsive to the user input, generating a second VI that comprises one or more concentric rings with icons for invoking corresponding applications, one or more icons more relevant to the inferred context being presented differently than one or more other icons,
wherein the virtual object comprises the second VI with the one or more concentric rings with the icons.

24. A wearable multimedia device, comprising:
an optical projection system;
at least one sensor;
at least one processor; and
at least one memory coupled to the at least one processor and storing programming instructions for execution by the at least one processor to perform operations comprising:
determining a three-dimensional (3D) map of a projection surface based on sensor data of at least one sensor of the wearable multimedia device;
in response to determining the 3D map of the projection surface, determining a distortion associated with a virtual object to be projected by an optical projection system on the projection surface;
adjusting, based on the determined distortion, at least one of (i) one or more characteristics of the virtual object to be projected, or (ii) the optical projection system; and
projecting, using the optical projection system and based on a result of the adjusting, the virtual object on the projection surface.

25. One or more non-transitory computer-readable media storing instructions that, when executed by at least one processor, cause the at least one processor to perform operations comprising:
determining a three-dimensional (3D) map of a projection surface based on sensor data of at least one sensor of a wearable multimedia device;
in response to determining the 3D map of the projection surface, determining a distortion associated with a virtual object to be projected by an optical projection system of the wearable multimedia device on the projection surface;
adjusting, based on the determined distortion, at least one of (i) one or more characteristics of the virtual object to be projected, or (ii) the optical projection system; and
projecting, using the optical projection system and based on a result of the adjusting, the virtual object on the projection surface.
